(19) United States
(12) Patent Application Publication
(10) Pub. No.: US 2017/0021901 A1
(43) Pub. Date: Jan. 26, 2017

(54) LIGHTING AND ENHANCED VISIBILITY FOR DIVERS

(71) Applicant: XS SCUBA, INC., Santa Ana, CA (US)

(72) Inventor: Thomas J. Phillipp, JR., Oceanside, CA (US)

(21) Appl. No.: 15/083,108

(22) Filed: Mar. 28, 2016

Related U.S. Application Data
(60) Provisional application No. 62/139,586, filed on Mar. 27, 2015.

(51) Int. Cl. B63C 11/12; G02C 9/00

(52) U.S. Cl. CPC B63C 11/12; G02C 9/00; B63C 2011/123

(57) ABSTRACT

Systems, devices, and methods are provided for underwater lighting and enhanced visibility for divers using interchangeable lens filters.

### CROSS-REFERENCE TO OTHER RELATED APPLICATIONS

The present application claims priority to U.S. Provisional Application No. 62/139,586 filed Mar. 27, 2015 titled “LIGHTING AND ENHANCED VISIBILITY FOR DIVERS” which is hereby incorporated by reference in its entirety and for all purposes.

### BACKGROUND

Various lighting environments occur in nature which can affect an individual's ability to perceive their surroundings. In particular, divers, snorkelers and swimmers can be exposed to bright conditions from both direct and reflected sunlight, moderate lighting conditions on cloudy days or in relatively shallow waters, low light conditions at sunrise, dusk or in relatively deep water and dark conditions at night or in very deep water.

To elaborate, after a diver suits up with all his gear, including his mask, until the time the dive is over and the diver is back on the beach or a boat, the diver's eyes are subjected to many types of lighting conditions. On a surface swim out on their back, the diver may experience bright sunshine reflecting off the surface of the water, diving shallow can subject the diver to bright conditions, while diving deep along a wall could result in low light conditions. The diver may also experience green water due to phytoplankton in the water.

Divers also experience a loss of color as they go deeper in the water column. As sunlight penetrates the water column, colors are filtered out by wavelength. As the diver descends the color red may dissipate first, starting around 15 ft. Traveling deeper, a diver can lose orange, yellow, and green. At 100 feet, a diver may only see blues and grays.

Current solutions to personal lighting for divers underwater include the use of hand held flashlights and electrical and chemical glow sticks. These can be dropped or lost however and provide limited benefit in murky water or bright conditions. Additionally, they may impair a diver's hand use since the flashlight or glow stick may be held by hand.

Two prior art U.S. Pat. Nos. 8,091,422 and 8,122,763 describe use of LED lights sealed within a diver's pressure hose. These LED's can change color with the remaining pressure inside of the diver's air cylinder but do not provide other functionality and benefits as described herein.

Regarding visual perception ability, underwater photographers or videographers sometimes add various filters to their cameras to compensate for color loss or variable lighting conditions. However, no similar prior art solution has allowed divers to have the same ability for their own eyes using traditional masks.

Few prior art solutions have attempted to solve these problem. Current solutions include wearing traditional sunglasses near the surface though, prior to descent, a diver necessarily must remove them and put on their diving mask. They then may be required to determine where and how to store their sunglasses.

In the world of commercial diving, some divers can add dark lenses to a full face mask or hard-helmet for the purposes of welding underwater. However, these are generally too dark to be useful for applications other than welding. Some of these hard-helmets are affixed to helmets that cover a diver's entire head or are full-face masks that cover mouth and chin, and are generally not considered similar to scuba masks that cover mainly a diver's eyes and nose. Some examples of prior art masks are Kirby Morgan underwater welding helmets and Interspiro welding masks.

Thus, needs exist for improved lighting and visual perception enhancement and optimization for divers, snorkelers and swimmers.

### SUMMARY

Provided herein are embodiments of devices, systems and methods of lighting that provide enhanced visual perception for divers, snorkelers and swimmers. In particular, hands-free illumination of individual users can be enhanced using Light Emitting Diodes (LEDs), Electroluminescent (EL) Wire, side-emitting fiber optics or a combination of these and visual perception can be enhanced through the use of changeable mask or goggle filters.

Buoyancy compensators with lighting systems described herein can provide improved safety, practicality and other benefits.

Also described herein are embodiments of devices systems and methods of making and using goggles and masks with changeable filters. The ability to add and remove different lenses or lens filters while underwater can provide enhancement of a diver's ability to see in varying conditions, providing additional safety and awareness for the diver.

The configuration of these devices is described in detail by way of various embodiments which are only examples.

Other systems, devices, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A is an example embodiment of a diver's buoyancy compensator with incorporated LED signaling from a side perspective view.

FIG. 1B is an example embodiment of a diver's buoyancy compensator with incorporated LED signaling from a side perspective view.

FIG. 1C is an example embodiment of a diver's buoyancy compensator with setup for incorporated LED signaling from a front view.

FIG. 1D is an example embodiment of a diver's buoyancy compensator with incorporated LED signaling lit up in a dark room from a side perspective view.

FIG. 1E is an example embodiment of a pocket of a diver's buoyancy compensator from a side perspective view.

FIG. 1F is an example embodiment of a power inflator mechanism for a diver's buoyancy compensator from a side perspective view.

FIG. 1G shows an example embodiment of a cylindrical fabric sleeve, located under the left pocket on a buoyancy compensator, that can house a battery compartment.

FIG. 2A is an example embodiment of a diver's buoyancy compensator with incorporated LED signaling from a side perspective view.

FIG. 2B is an example embodiment of a diver's buoyancy compensator with setup for incorporated LED signaling from a front view.

FIG. 2C is an example embodiment of a diver's buoyancy compensator with incorporated LED signaling lit up in a dark room from a side perspective view.

FIG. 2D is an example embodiment of a left side pocket for a diver's buoyancy compensator a side perspective view.

FIG. 2E is an example embodiment of a right side pocket for a diver's buoyancy compensator a side perspective view.

FIG. 2F is an example embodiment of a diver's buoyancy compensator from a rear view.

FIG. 2G is an example embodiment of a diver wearing a diver's buoyancy compensator with incorporated LED signaling from an upper rear view.

FIG. 2H is an example embodiment of a male diver and female diver wearing diver buoyancy compensators with incorporated LED signaling from an upper side perspective view.

FIG. 3 is an example embodiment of a diver's buoyancy compensator with incorporated Electroluminescent (EL) Wire signaling from a side perspective view.

FIG. 4 is an example embodiment of a dive mask frame with interchangeable filter using clips for attachment from an upper front-side perspective view.

FIG. 5 is an example embodiment of a dive mask frame with a slot for receiving an interchangeable filter from an upper front-side perspective view

FIG. 6 is an example embodiment of a rear view and front view of interchangeable filters with gripping tabs for use with a slotted dive mask.

FIG. 7A is an example embodiment of a dive mask frame having a round lock receiving hole and a slot with a rounded upper proximal edge from an upper front-side perspective view.

FIG. 7B is an example embodiment of a dive mask frame having a round lock receiving hole and a slot with a rounded upper proximal edge from a close side view.

FIG. 8A is an example embodiment of a dive mask frame having a round lock receiving hole and a slot with a chamfered upper proximal edge from an upper front-side perspective view.

FIG. 8B is an example embodiment of a dive mask frame having a round lock receiving hole and a slot with a chamfered upper proximal edge from a close side view.

FIG. 8C is an example embodiment of a dive mask frame having a round lock receiving hole and a slot with a chamfered upper proximal edge a close upper front-side perspective view.

FIG. 8D is an example embodiment of a rotatable lock tab for use with a dive mask frame having a round lock receiving hole from a lower-side perspective view.

FIG. 9A is an example embodiment of a dive mask frame having a round lock receiving hole with a notch and a slot with a chamfered upper proximal edge from an upper front-side perspective view.

FIG. 9B is an example embodiment of a dive mask frame having a round lock receiving hole with a notch and a slot with a chamfered upper proximal edge from a close upper front-side perspective view.

FIG. 9C is an example embodiment of a rotatable lock tab for use with a dive mask frame having a round lock receiving hole with a notch.

FIG. 9D is an example embodiment of a dive mask frame having a round lock receiving hole with a notch and a slot with a chamfered upper proximal edge with mask skirt attached and interchangeable filter inserted from an upper rear-side perspective view.

FIG. 9E is an example embodiment of a dive mask frame having a round lock receiving hole with a notch and a slot with a chamfered upper proximal edge with mask skirt attached and interchangeable filter inserted from a close upper rear-side perspective view showing insertion orientation.

FIG. 9F is an example embodiment of a dive mask frame having a round lock receiving hole with a notch and a slot with a chamfered upper proximal edge with mask skirt attached and interchangeable filter inserted from a close side perspective view showing insertion orientation.

FIG. 9G is an example embodiment of a dive mask frame having a round lock receiving hole with a notch and a slot with a chamfered upper proximal edge with mask skirt attached and interchangeable filter inserted from a close upper front-side perspective view showing pre-insertion and post-insertion with rotation orientation.

FIG. 10A is an example embodiment of a dive mask with mask skirt and adjustable headband attached and interchangeable filter inserted with rotatable lock in locked position from an upper front-side perspective view.

FIG. 10B is an example embodiment of a dive mask with mask skirt attached and interchangeable filter inserted with rotatable lock in locked position from a front view.

FIG. 10C is an example embodiment of a dive mask with mask skirt and adjustable headband attached, rotatable lock in unlocked position and interchangeable filter not fully inserted from an upper front-side perspective view.

FIG. 10D is an example embodiment of a diver manipulating a dive mask with mask skirt and adjustable headband attached, rotatable lock in unlocked position and interchangeable filter not fully inserted from an upper front view.

FIG. 10E is an example embodiment of a diver wearing a snorkel coupled with a dive mask with mask skirt and adjustable headband attached and interchangeable gray filter inserted with rotatable lock in locked position from a front-side perspective view.

FIG. 10F is an example embodiment of a diver wearing an interchangeable filter lens caddy on a forearm and a dive mask with mask skirt and adjustable headband attached and interchangeable amber filter inserted with rotatable lock in locked position from an upper front-side perspective view.

FIG. 10G is an example embodiment of a dive mask frame with mask skirt and adjustable headband attached and interchangeable amber filter inserted with rotatable lock in locked position from an upper front-side perspective view.

FIG. 11A is an example embodiment of a diver removing an interchangeable filter for use with a dive mask from an interchangeable filter lens caddy on a forearm, from an upper front-side perspective view.

FIG. 11B is an example embodiment of a diver wearing an interchangeable filter lens caddy worn on a forearm in a closed orientation, from an upper front-side perspective view.

FIG. 11C is an example embodiment of an interchangeable filter lens caddy in a closed orientation, from an upper front view.

FIG. 12A is an example embodiment of a diver wearing an interchangeable filter lens caddy from a side view.

FIG. 12B is an example embodiment of an interchangeable filter lens caddy with straps from an upper oblique perspective view.

FIG. 12C is an example embodiment of a diver wearing an interchangeable filter lens caddy with a zipper from an upper back-side view.

FIG. 13A is an example embodiment of a closed carrying case having a body with a sealable flap to access an interior compartment from a side perspective view.

FIG. 13B is an example embodiment of a carrying case having a body with an open sealable flap to access an interior compartment including expandable dividers from a side perspective view.

FIG. 13C is an example embodiment of a carrying case having a body with a closed sealable flap to access an interior compartment from a side perspective view.

### DETAILED DESCRIPTION

Before the present subject matter is described in detail, it is to be understood that this disclosure is not limited to the particular embodiments described. It is also to be understood that the terminology used herein is for the purpose of describing particular embodiments only and is not intended to be limiting, since the scope of the present disclosure will be limited only by the appended claims.

Provided herein are lighting and visual enhancement systems and methods. The devices, systems and methods described herein can be configured to illuminate a user and to provide enhanced visual perception in underwater environments and others.

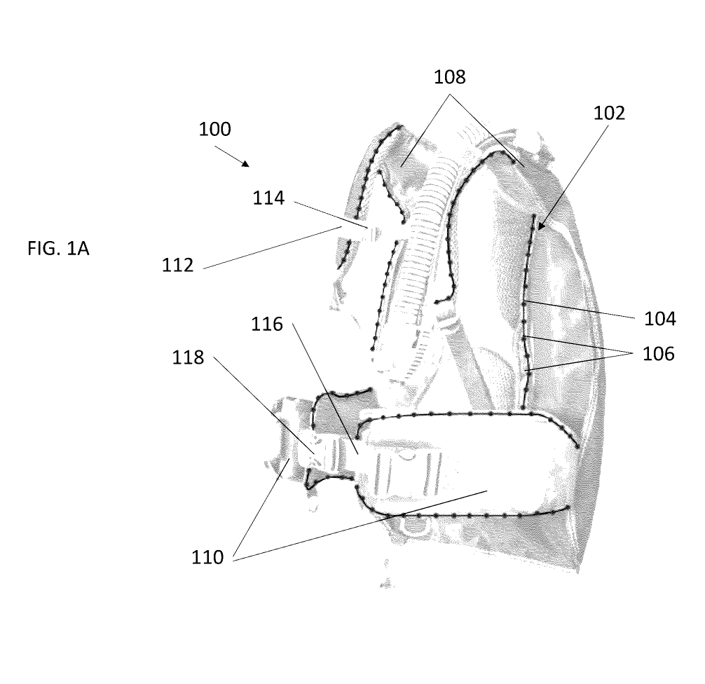

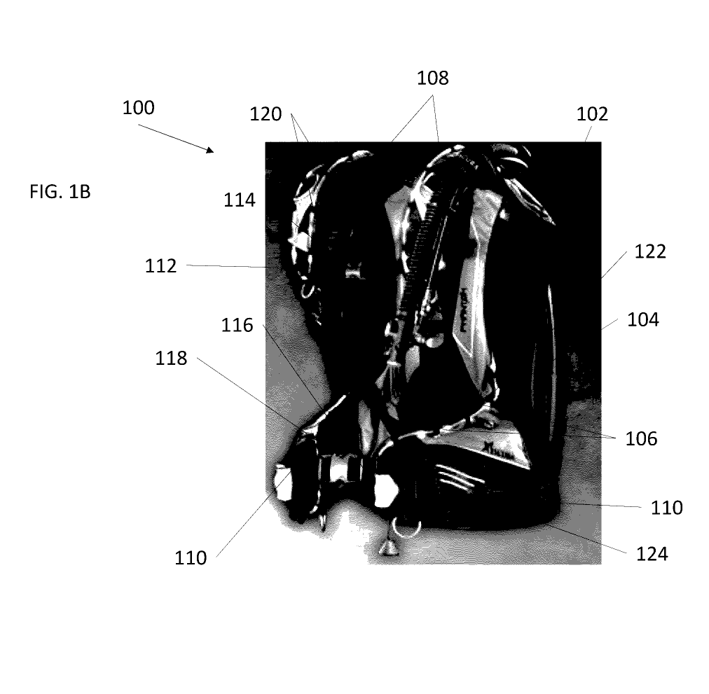

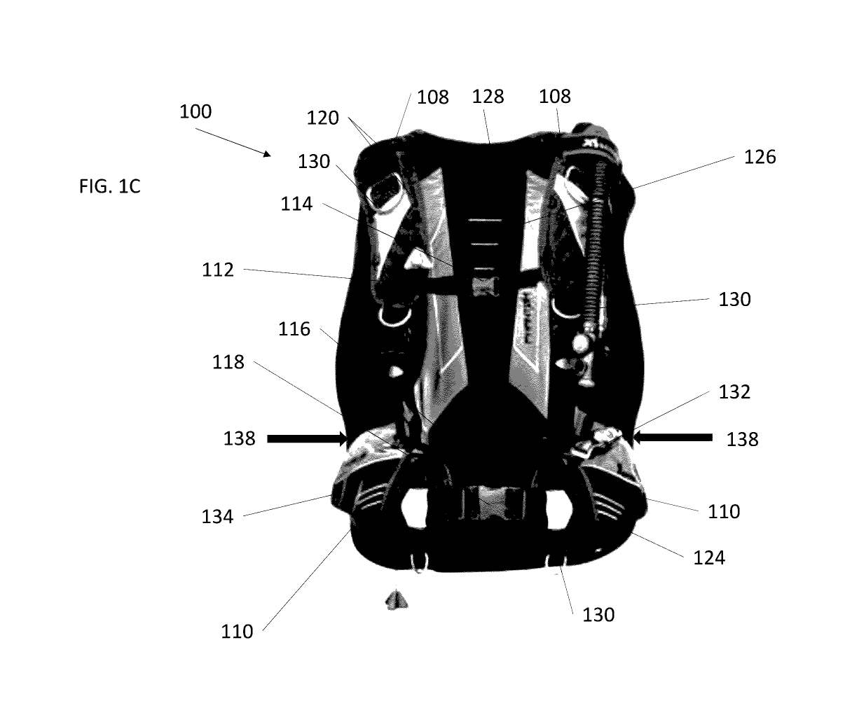

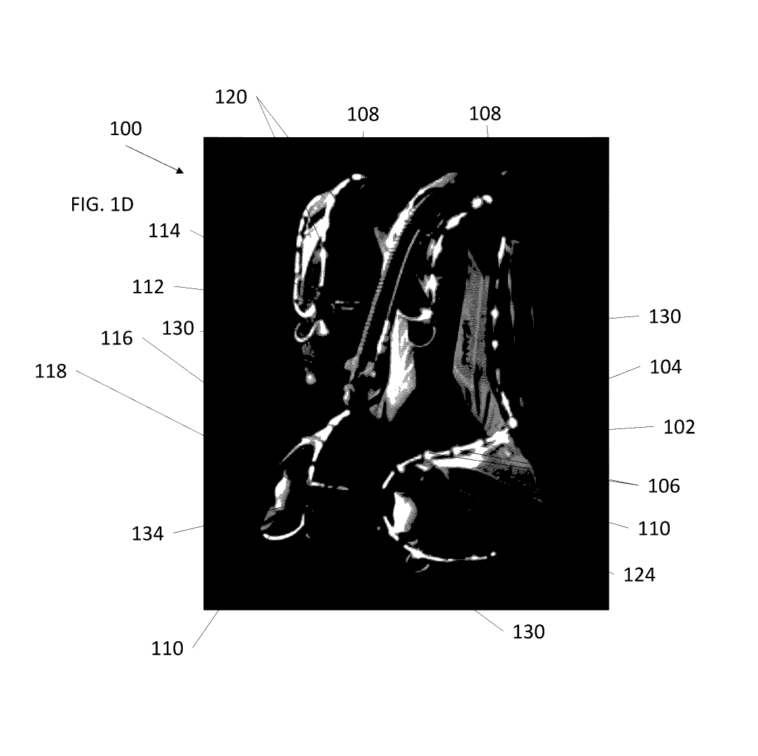

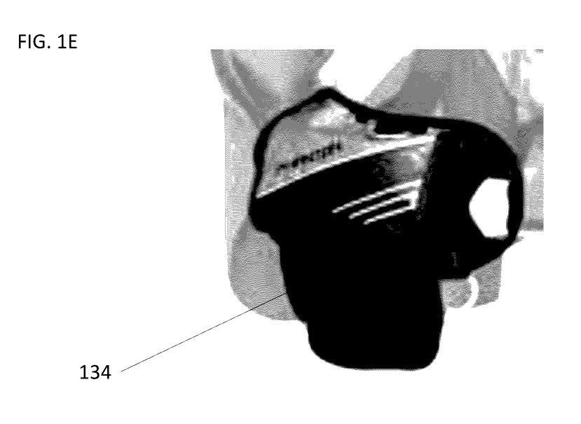

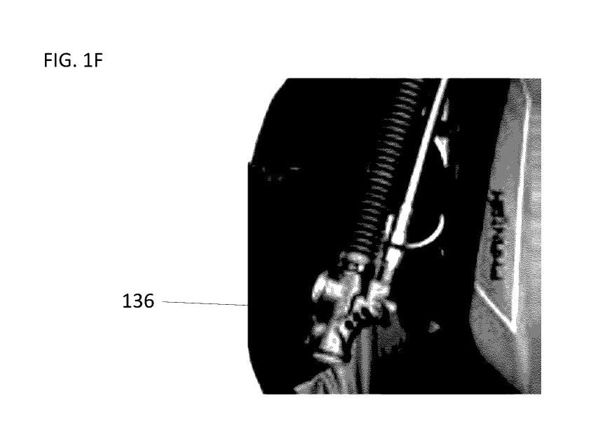

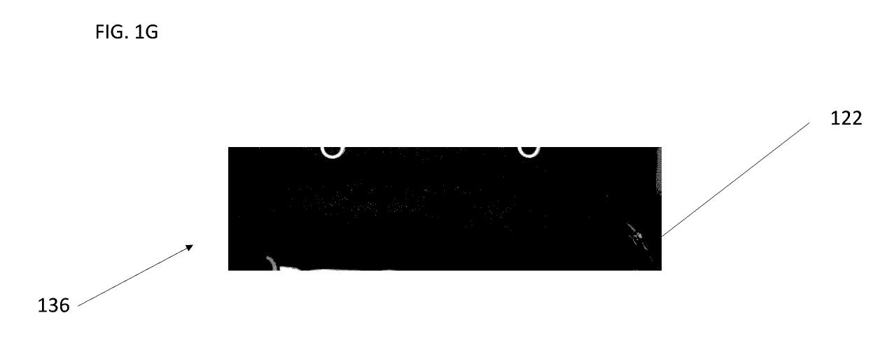

FIG. 1A is an example embodiment of a diver's buoyancy compensator (BC) 100 with incorporated LED lighting system 102. In the example embodiment at least one LED light string 104 can include a plurality of LED lights 106 and can be attached to buoyancy compensator 100 which is a vest or jacket that a diver wears to hold an air tank on a diver's back and to help maintain the diver's buoyancy in the water column. LED lights 106 can be arranged such that buoyancy compensator 100 can be seen from virtually every angle around a diver. For instance, shoulder straps 108 of the buoyancy compensator 100 are arranged from an area on the user's back, over the user's shoulders and down the user's chest. LED light strings 104 are arranged on the shoulder straps 108 to extend from the user's back, over the user's shoulders and down the user's chest. This can provide visual signaling from behind a user, above a user, in front of a user and on either side of a user. Similarly, waist straps 110 can extend from a user's back area around each side of a user and across a user's stomach area. LED light strings 106 can be arranged on an upper and lower side of waist straps 110 such that the LED lights can be seen from behind a user, from each side of a user, from in front of a user and from below a user. As shown in the example embodiment an LED light strand 104 can also extend along either buoyancy compensator 100 from shoulder straps 108 down to waist straps 110 in a substantially vertical fashion.

A BC chest strap 112 can provide security from the BC coming loose or otherwise slipping off of a diver and can be fastened using at least one clip 114. A waist securing mechanism 116 can be used to couple waist straps 110 using at least one clip 118 or other mechanism.

LED lights 106 shown in FIGS. 1A-1D are located in at least one LED string 104 at regular intervals from each other. In some embodiments LED lights 106 can be located at irregular intervals or in different arrangements as appropriate in order to indicate different locations on a user's buoyancy compensator. For instance, a cluster or group of LED lights 106 can be located on shoulder straps 108, while a different cluster or group of LED lights 106 can be located on a rear of the buoyancy compensator 100, while yet a different cluster or group of LED lights 106 can be located on waist straps 110 of buoyancy compensator 100. This differentiation can aid other individuals with identifying a user's body orientation while underwater when limbs or other visual cues may not be easily visible in low or no light or murky conditions.

The LED lights 106 used in the example embodiment can be powered by electrical coupling with one or more battery sources (not shown) which can be dedicated solely for LED power or can be used with other systems or devices which require electrical power. A dedicated switch or button can be used to turn the whole system or individual portions of the system on and off. Alternatively or additionally, control can be integrated into other systems which a diver, swimmer or snorkeler can use, such as an app on a smartphone. In some embodiments batteries can be charged through movement or with solar cells. As the system is to be used in marine or other environments with water, watertight or waterproof enclosures or housings can be used for all electrical components.

In some embodiments multiple LED colors can be incorporated and color can be changed to signal other individuals nearby, depending on the user's requirements. For instance, normal or standard operation could be indicated using white light LEDs while ascending in a water column could be indicated using green light LEDs. Blue light LEDs could indicate descending in a water column while red light LEDs could indicate an emergency. Color changes can be activated using an electrically coupled switch or control panel which can be on a dedicated or multi-functional device. Color changes can also be activated automatically when using pressure, velocity or other sensors. Components should also be able to maintain proper functioning at intended use depths and pressures.

In some embodiments different color LEDs can be used to indicate different members of a dive team. For instance, a dive leader or instructor can have white light LEDs which are brighter than trainee divers which are each indicated by different color LEDs such as purple, yellow, orange or other colors. Likewise, different signaling patterns such as flashing, strobing, constant lighting and various others can be used to indicate various conditions or users. Lights can be different for instructors at the front of a group, such as white, and a back of a group, such as red. Additionally, white lights could indicate an individual BC front or forward facing direction while the same BC could have red lights on a back or rear area. Buddy teams of divers could also have color coordinated lights in order to recognize each other.

In various embodiments, lighting systems described herein can provide ambient light around a diver's body, improving visibility of instrumentation, clips, lanyards, pockets, gadgets and other devices and items in dark environments, such as in caves or at night. Additionally, in some embodiments lighting can be used to attract particular species of wildlife for closer encounters. As such, in various embodiments divers can customize BC's with unique colors or combinations of colors.

FIG. 1B shows an example embodiment of a low profile BC 100 that allows a user to be more streamlined in the water than traditional BCs. It can include lighting system 102 as described herein as well as various weight systems.

In the example embodiment a series of small elastic loops 120 can be sewn to buoyancy compensator 100 at regular intervals and can maintain the arrangement of the at least one LED string 104. Other attachments which can be used in supplementary or complementary fashion include grommets, sewing, adhesives, clips, pinch clips, tension clips, tubing and others.

In the embodiment shown, the lighting system 102 includes a string 104 of micro-LED lights 106 sealed in a solid, waterproof transparent casing 122. Casing 122 can have various dimensions such as 4 mm diameter. Casing 122 can be removably or permanently threaded through the series of small elastic loops 120 that line a perimeter of the BC 100. The BC 100 with lighting system 102 has many applications in the categories of safety, practicality and fun. In some embodiments casing 122 can be PVC. Casing 122 can protect lighting in various embodiments to various underwater depths. In some embodiments, this can be near 150 feet.

Other example embodiments can use various other components to maintain LED string positioning with respect to a BC including: grommets, sewing, adhesives, clipping using pinch or tension clips, inserting into transparent tubing and others.

In the example embodiment a dedicated sleeve (not shown) for a battery pack can be located in various locations, such as under a left pocket 124 that can be used to store small items like a pair of gloves. In some embodiments the sleeve itself can be sealed such that it is waterproof in addition to a battery pack itself being waterproof.

In some embodiments BC 100 can include an integrated weight system. In some embodiments, it can be back inflated. For back inflated BC's, by having a complete air cell behind the diver, the area in front of a diver can be left unobstructed and opened up as compared with some prior art BCs. As such a diver can more easily see any hardware and also any pockets such as left pocket 124. Wraparound BC's can offer better stability and maintain divers in a vertical orientation at the surface of the water they are diving in. An integrated weight system can be simple for divers to load while remaining secure and also be simple to remove or otherwise detach when desired and can be included in both wraparound and back inflated BCs.

In various example embodiments, different size BC's can be created and worn for different diver body shapes and sizes. In some example embodiments, a small number of sizes, such as four, can satisfy a size range of human body sizes from very small to very large.

BCs 100 can be manufactured in various colors in different embodiments. In the example embodiment, neutral colors of the BC can allow a diver to accessorize with any color choice.

Dump valves can be included in various embodiments. In the example embodiment a cable-activated rapid exhaust valve can be provided at the top of the airway. A right shoulder pull dump can also be included. A lower, rear pull dump can also be included.

In the example embodiment the lights shown are white. Lighting system 102 including mounts 120 can be removable or added to third party BC's in some embodiments.

FIG. 1C is an example embodiment of a diver's buoyancy compensator 100 with lighting system 102 removed from a front view. In the example embodiment, a padded spine and lumbar support 126 can provide back comfort for a diver. A rolled neck collar 128 can protect the diver's neck from abrasion. Various stainless steel D-rings 130 can provide a diver with many attachment options for gear, weight, or both.

Knife mounting grommets 132 are shown in the example embodiment on BC 100s left side which can allow a diver to removably couple a knife. A pull down right pocket 134 can accommodate or otherwise store writing slates, small lights or a spare mask. A bladder retractor can be used to pull in the sides of a BC bladder during deflation, keeping the BC streamlined and reducing drag. In some embodiments a bladder retractor can be an elastic band that attaches to a BC bladder at locations 138 and can run along or otherwise be coupled to the back of the harness. Bladder retractors can pull in bladder material as a diver deflates a bladder, keeping it streamlined.

FIG. 1D is an example embodiment of a diver's buoyancy compensator 100 with incorporated lighting system 102 lit up in a dark room from a side perspective view. A harness system as shown in FIGS. 1A-1D can eliminate the necessity for a hard pack on example embodiments of BCs 100. The harness system can include the shoulders, back and waist components of BC 100 without an air bladder on the back. As such, it can maintain a cylinder or other air holding device in close proximity with a diver's back. It can also maintain the cylinder in a fixed position such that it does not slide down the diver's back. Tank bands can include a stainless steel cam buckle with external adjustment.

FIG. 1E is an example embodiment of a fold down utility pocket 134 for a diver's buoyancy compensator a side perspective view.

FIG. 1F is an example embodiment of a micro inflator mechanism 136 for a diver's buoyancy compensator a side perspective view. A Micro Inflator mechanism 136 can inflate and deflate a BC and can include a drift pin design, which provides greater reliability and longevity than inflators relying upon typical Schrader valves.

FIG. 1G shows an example embodiment of a cylindrical fabric sleeve 136, located under a left pocket on a buoyancy compensator, that can house a battery pack compartment. A light string can be electrically coupled to a battery pack and exit a rear opening of the sleeve 136. The light string can then be threaded through small elastic loops along the perimeter of the BC or otherwise be affixed to the BC.

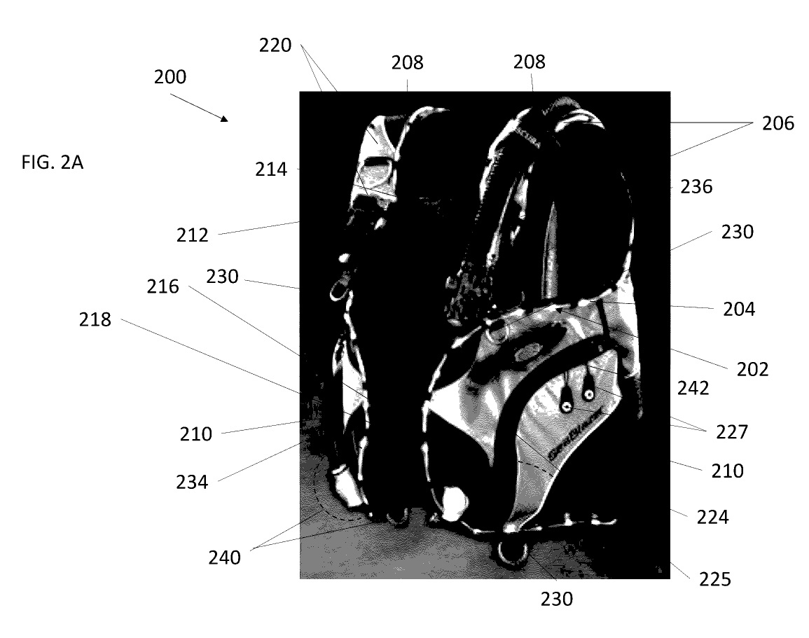

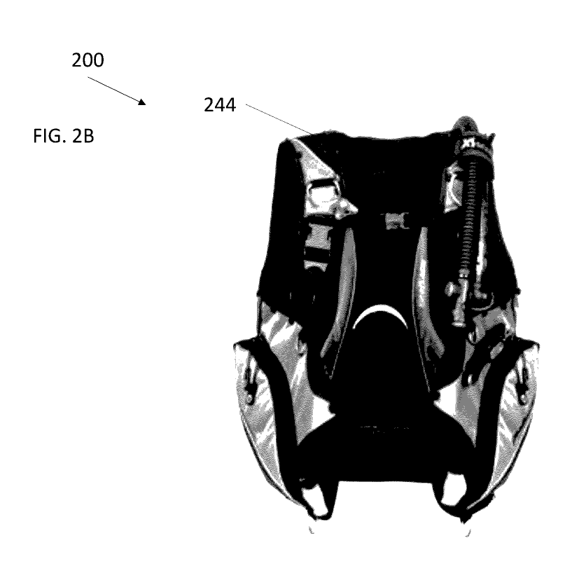

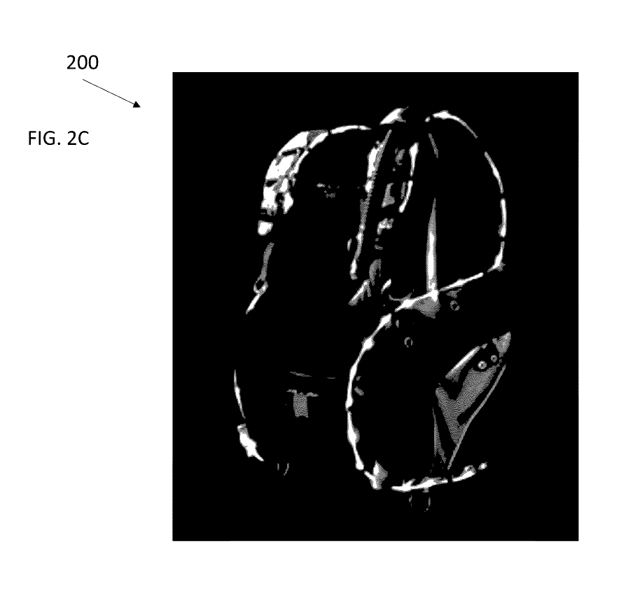

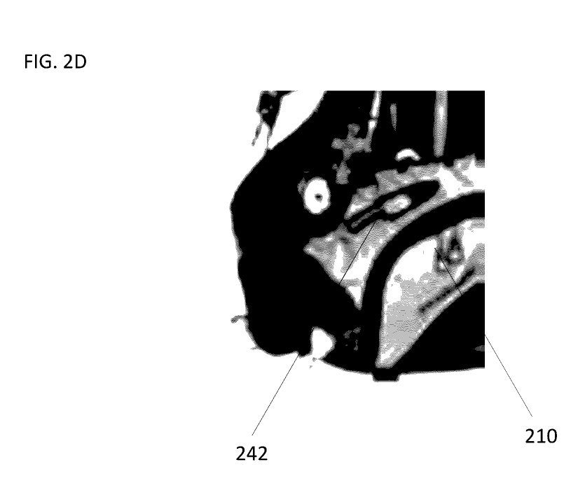

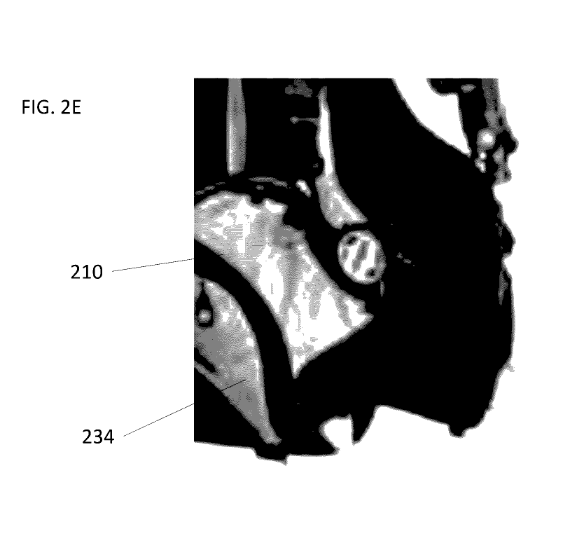

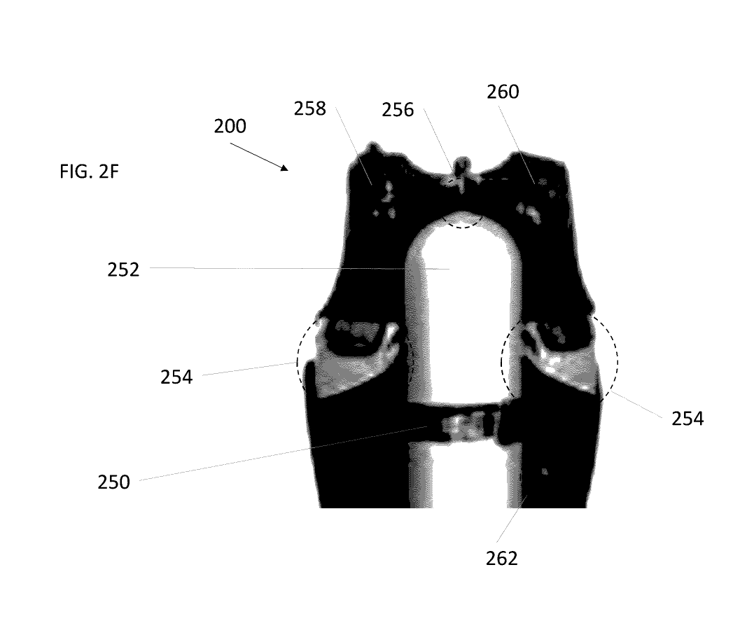

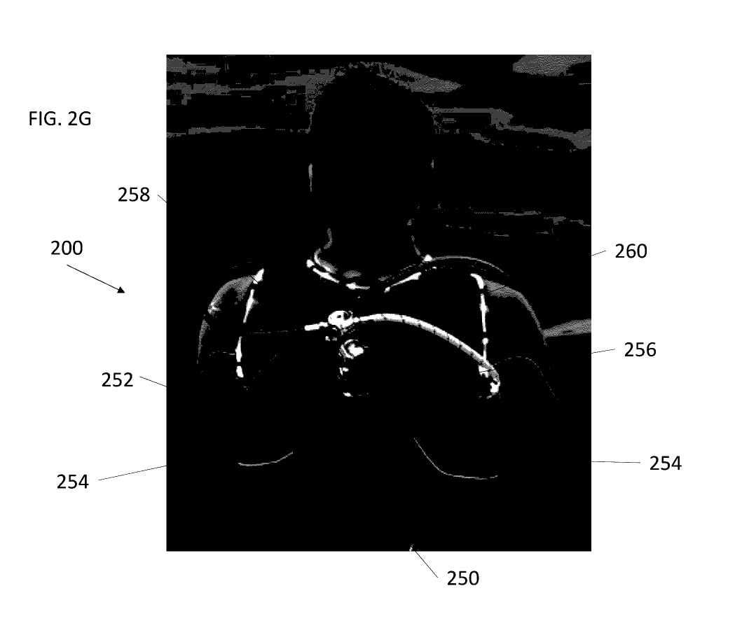

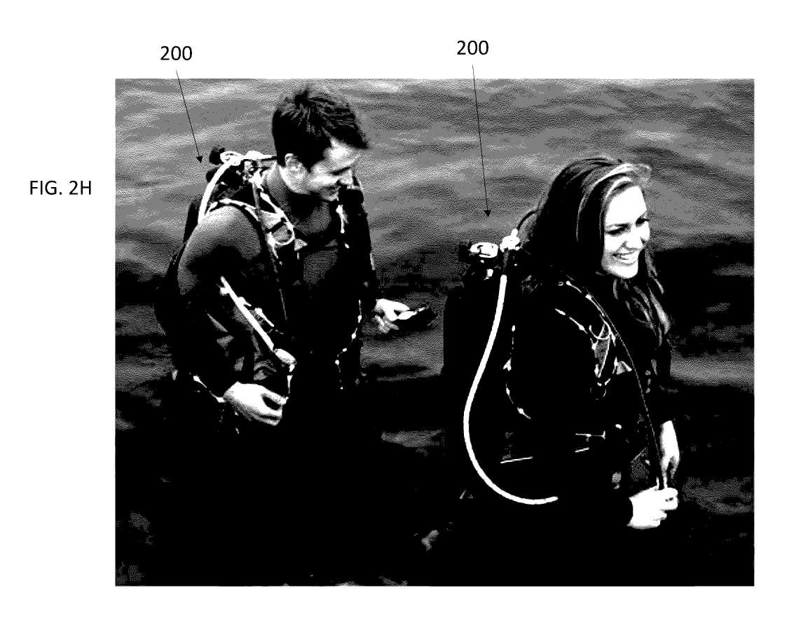

FIG. 2A shows an example embodiment of a wrap-around, jacket style BC 200 that provides lift at a diving surface along with stability and security at depth underwater. It can include lighting systems 202 as described herein as well as various weight systems. The jacket style BC 200 can be a high-quality, weight-integrated, jacket style BC. In the example embodiment one or more air cells within lower arms 210 can wrap around a diver's torso, allowing BC 200 to provide vertical orientation at the surface and improved lift in the water. A perimeter of BC 200 can integrate lighting system 202. An integrated weight system located at locations 240 including handles can be easy to load while also remaining secure in use and easy to ditch or remove during a dive. Divers can pull one or both of these handles to jettison lead weights.

Large utility pockets 224 and 234 on either side of lower arms 210 can have zippers 225 with dual zipper pulls 227 for ease of entry. The two-piece waist band can be formed by lower arms 210 and can be adjustable in the back to accommodate a wide range of waist sizes. In the example embodiment shown in FIG. 2A, it can be a two-piece waistband about four inches wide, similar to a cummerbund that attaches using Velcro in the front. The two pieces can be adjustable in the back.

On top of that cummerbund are two pieces of webbing joined by a side-release fastex clip. This is the waist strap. It sits on top of the waistband. In various embodiments, neutral colors of BC 200 can allow the diver to accessorize with any color choice. A Micro Inflator 236 can use a drift pin design, which provides greater reliability and longevity than inflators relying upon standard Schrader valves. A two-piece back pack can feature a lowered tank band to better integrate with the BC's waist band 218. A plurality of stainless steel D-rings 230 provide many attachment options. A chest strap 212 provides added security.

FIG. 2B is an example embodiment of a diver's buoyancy compensator 200 with incorporated lighting systems 202 from a front view. An integrated carrying handle 244 is built into the back pack.

FIG. 2C is an example embodiment of a diver's buoyancy compensator 200 with incorporated lighting systems 202 lit up in a dark room from a side perspective view.

FIG. 2D is an example embodiment of a left side pocket for a diver's buoyancy compensator 200 a side perspective view. Some BC's 200 can include useful instruments behind a left pocket 210 and out a scooped opening on a top, front of the lobe. Knife mounting grommets 240 on the left side of BC 200 accommodate a BC knife 242.

FIG. 2E is an example embodiment of a right side pocket for a diver's buoyancy compensator 200 a side perspective view. A scooped opening on a top, front of a right lobe can be used for stowing and deploying an octopus. An octopus is an alternate regulator that can be given to another diver. The octopus can remain visible and secure throughout a dive in this configuration.

FIG. 2F is an example embodiment of a diver's buoyancy compensator 200 a rear perspective view. A tank band 250 can features a stainless steel cam buckle with external adjustment. A tank positioning strap at location 256 around a base of a cylinder valve can allow a diver to set a cylinder 252 to a preferred height for each use. Optional trim weight pockets can be included in some embodiments that may be added to a tank band to increase weight capacity or provide optimal positioning in the water while Non-ditchable trim weight pockets 254 found on the back of the BC 200 can increase an overall weight capacity as well as provide better positioning in the water.

In the example embodiment, three dump valves are available: a cable-activated rapid exhaust valve at the top of an airway, a right shoulder pull dump 260 and a lower, rear pull dump 262.

FIG. 2G is an example embodiment of a diver wearing a diver's buoyancy compensator 200 with incorporated lighting systems 202 from a rear view.

FIG. 2H is an example embodiment of a male diver and female diver wearing diver buoyancy compensators 200 with incorporated lighting systems 202 from a side perspective view.

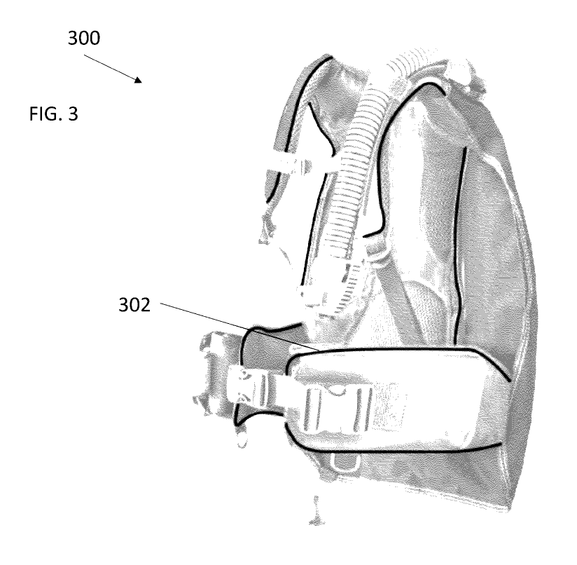

FIG. 3 is an example embodiment of a diver's buoyancy compensator 300 with incorporated Electroluminescent (EL) Wire 302 from a side perspective view.

It should be understood that although the embodiments described above are directed toward a buoyancy compensator, other embodiments can include LEDs, EL Wires, side-emitting fiber optics or others attached to wetsuits, fins, hoods, goggles, masks, gloves, snorkels, regulators, rebreathers, dry suits, tanks, air lines, bracelets, necklaces, anklets, rings, belts, headbands, vests and others.

Lighting systems and methods as described in FIGS. 1-3, are not limited strictly to embodiments with BC's, but can also be used in various embodiments in accordance with personal or multi-user propulsion vehicles, submarines, wetsuits, hoods, fins, snorkeling vests, snorkels, goggles and others. One example is a dive club holding an underwater Christmas tree trimming party event.

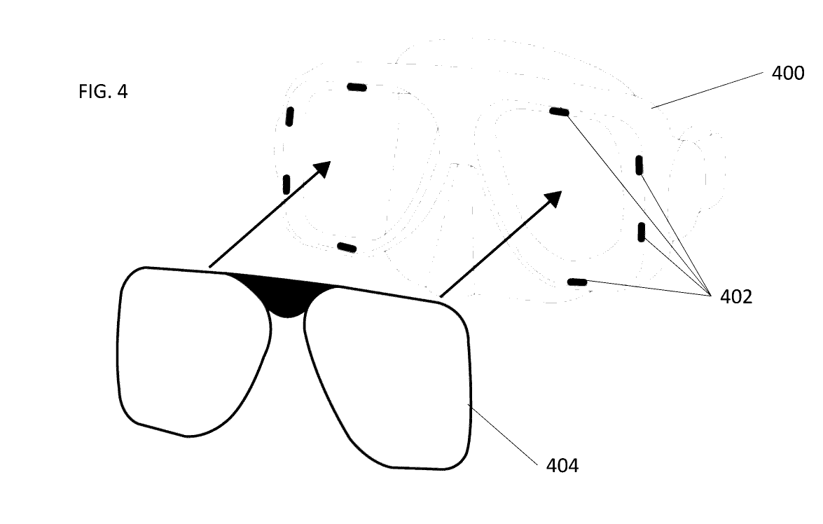

FIG. 4 is an example embodiment of a dive mask frame 400 with interchangeable filter 404 using clips 402 for attachment from an upper front-side perspective view. In the example embodiment clips 402 are used to attach the lens filter 404 to the mask frame 400. Other attachments mechanisms include suction cups, hinges, adhesives, friction, films, and others that can be used to secure lens filters to lenses or frames. Although embodiments described herein are described in the context of diving or snorkeling masks, different eye protection uses are contemplated in various embodiments, such as swim goggles, as well as those for personal watercraft, snow-skiing or snowboarding, motorcycle riding, safety glasses, and others. In some example embodiments a dive mask with interchangeable filters can include using clips for attachment where protrusions on clips securely fit in holes on dive mask filters but can be removed or swapped during a dive. An inverted arrangement and mixed arrangements also exist in various embodiments. Interchangeable filters with suction cups for attachment to a dive mask can include one or more suction cups to secure a filter to a lens or lenses of a dive mask. Suction cups can either be on lenses or on filters in various embodiments.

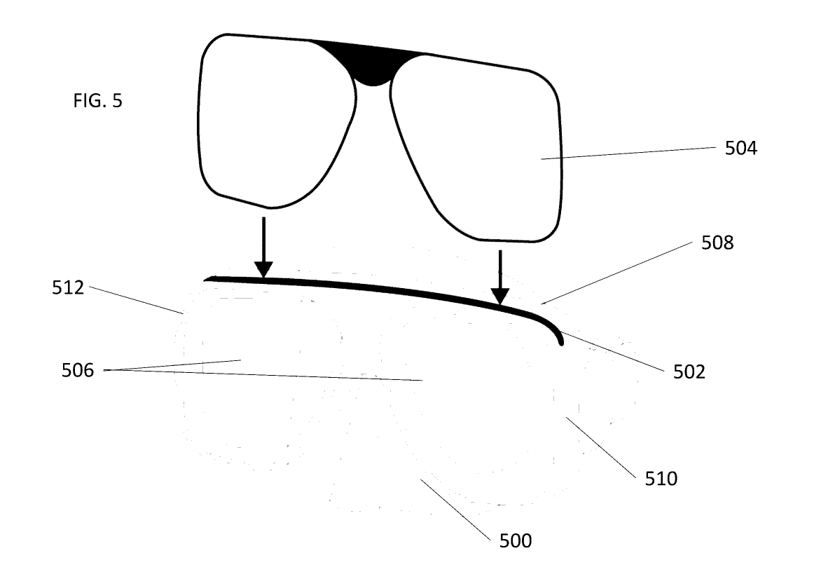

FIG. 5 is an example embodiment of a dive mask frame 500 with a slot 502 for receiving an interchangeable filter 504 from an upper front-side perspective view. Slot 502 is located on an upper surface 508 in the example embodiment and can be a channel for slidably receiving interchangeable filter 504 of comparable or slightly larger width than interchangeable filter 504. In other embodiments, slot 502 can be located on an upper surface 508, lower surface 510, side surface 512 or side surface 514 of dive mask 500 in various embodiments. As such, slot 502 can allow for an interchangeable filter to be slid, dropped or rotated into place to cover one or more clear lenses 506 such that a user's view is enhanced for the particular natural lighting conditions the user is experiencing. In the example embodiment shown, dive mask 500 has a pair of normal, clear lenses 506 on a proximal side of slot 502 which the user looks through when wearing. In some embodiments, there can be a second pair of clear lenses 506 on a distal side of slot 502. In some embodiments there can be combinations of one or more lenses as appropriate.

In some embodiments natural lighting can be bright such as in direct sunlight above water, reflected sunlight on water's surface or underwater near the water's surface on a bright day. In these conditions a user can use a filter which provides sunlight protection for the user's eyes, similar in nature to sunglasses. The filter can be polarized or non-polarized in various embodiments. Similarly, lighting can be affected by phytoplankton which can turn the water green, dark conditions in deep water which can remove red, orange, yellow and green colors, and others and various filters can be used to compensate for varying conditions. Filters can also be used to enhance a user's ability to perceive a particular light source which other users can be using in particular conditions. For instance, if a dive leader is using red LED's to enhance a dive team's visibility and other members of the team are using orange LED's, a filter can enhance a user's ability to identify individual members of the team by filtering out non-critical colors or keying on LED colors.

In some embodiments a traditional dive mask frame, can be extend with an outer frame attached that has one or more slots in the top, such that one or more lens filter can be dropped in front of the existing mask lens. In various embodiments a locking mechanism can lock in the lens filter in place so it would not fall out.

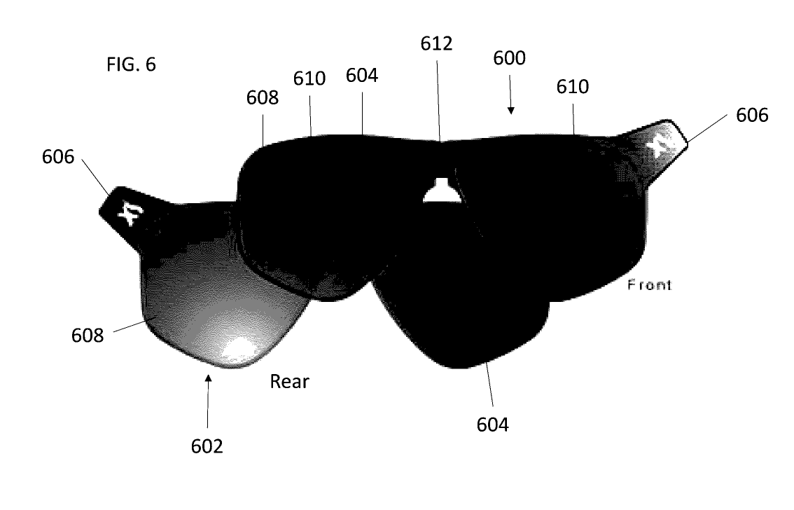

FIG. 6 is an example embodiment of a rear view 602 and front view 600 of interchangeable filters 604 with gripping tabs 606 for use with a slotted dive mask. In the example embodiment, filters 604 each include a body 608 and gripping tab 606 coupled in a monolithic structure. Interchangeable filters 604 can have various degrees of tinting in different embodiments and can be customized for particular lighting conditions. Examples of different filters include amber, red, green, different shades of blue, and others.

In some embodiments, multiple filters can be used for a single dive mask, for example one body and gripping tab for each lens 610 where lenses 610 are not coupled by a frame 612.

In various embodiments different patterns can be used on an outward facing surface of lens filters which can indicate a user's identity where few if any other identifying characteristics can be seen underwater. Non-limiting examples of patterns include bloodshot eyes, surprised eyes, creature eyes, winking eyes, solid colors, spots, stripes, stars, squares, holograms and others. In some embodiments these patterns are applied to a front-facing surface of a lens filter while in other embodiments these patterns can be integrated in a larger manufacturing process.

In various embodiments, filters 604 can be removed or replaced during a dive without removing a mask, even with gloves on. In some embodiments filters 604 can be inserted in a slot either right handed or left handed and as such, no true front or rear exists.

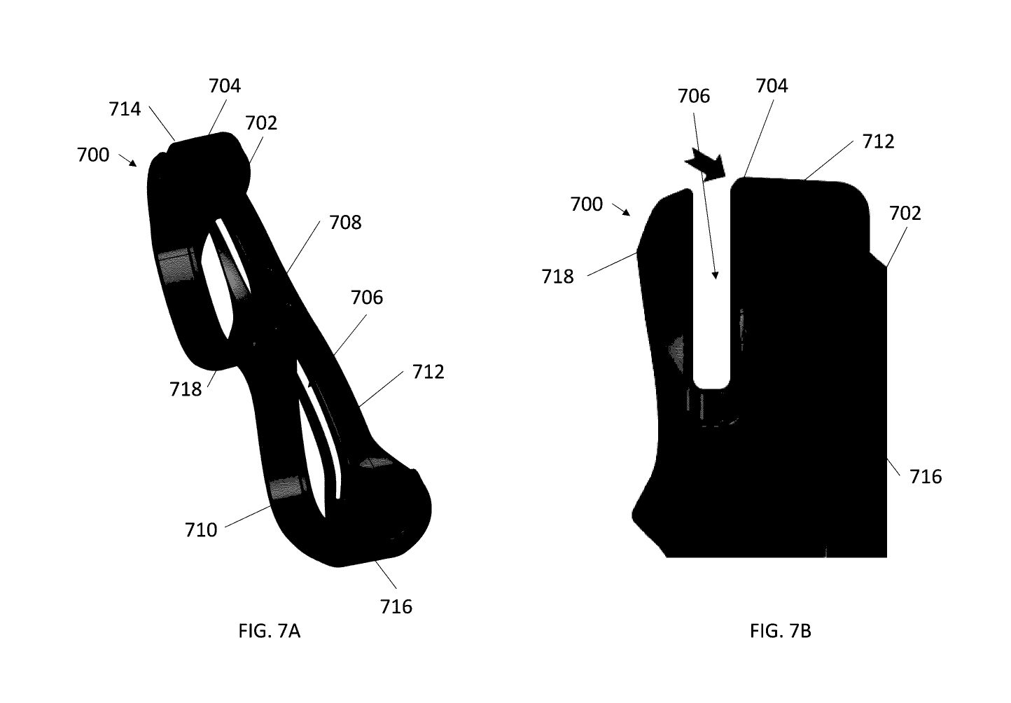

FIG. 7A is an example embodiment of a dive mask frame 700 having a round lock receiving hole 708 and a slot 706 with a rounded upper proximal edge 704 from an upper front-side perspective view. In the example embodiment slot 706 is located in a proximal area of upper surface 712 and spans across the entirety of upper surface 702 of frame 700, even rounding sides 714 and 716. In various embodiments, a lower interior surface 710 can have a channel for slidably coupling with interchangeable filters.

FIG. 7B is an example embodiment of a dive mask frame 700 having a slot 706 with a rounded upper proximal edge 704 from a close side view of side 716. As shown, slot 706 may extend down side 716 and 714 to a brow region 718 of frame 700.

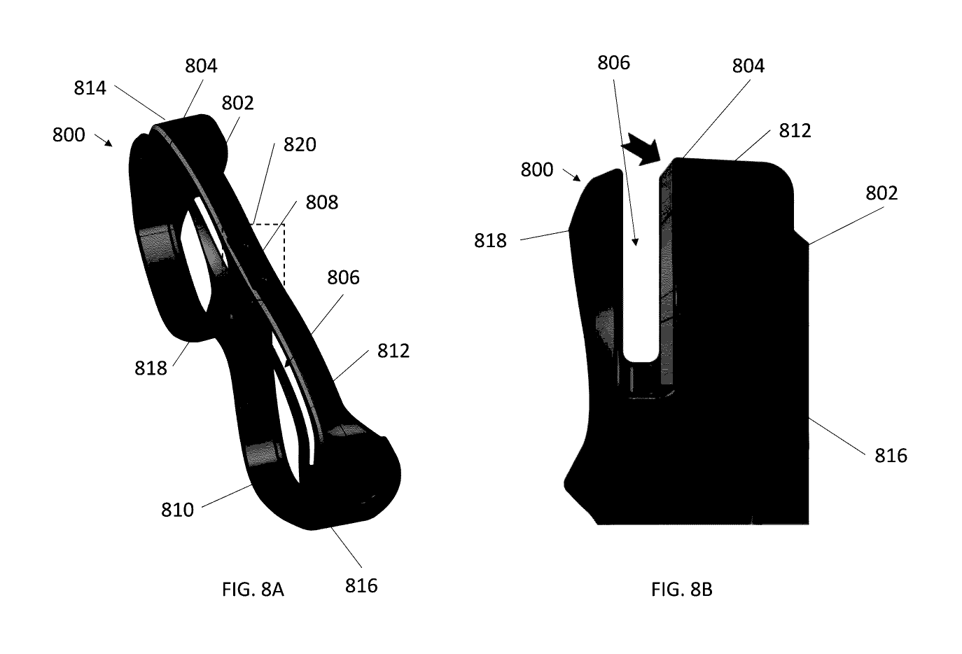

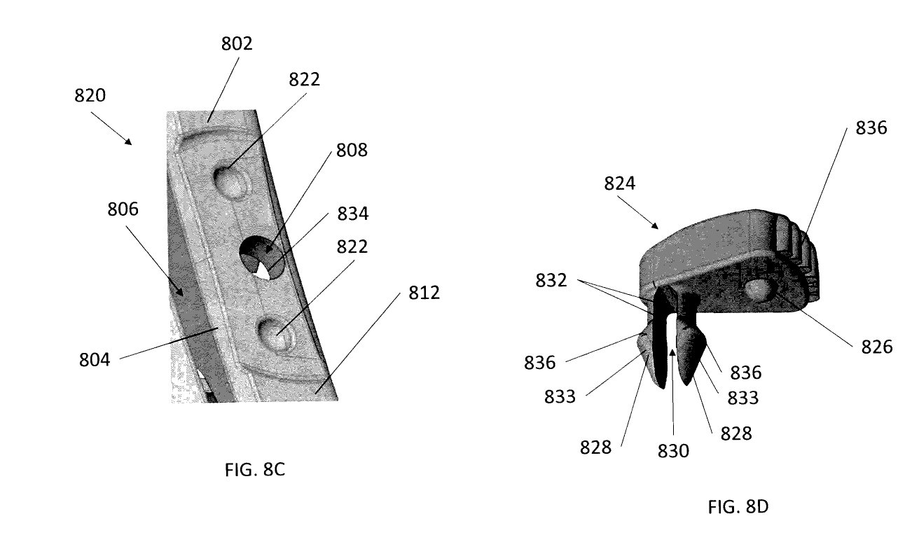

FIG. 8A in an example embodiment of a dive mask 800 having a round lock receiving hole 808 and a slot 806 with a chamfered upper proximal edge 804 from an upper front-side perspective view. In the example embodiment slot 806 is located in a proximal area of upper surface 812 and spans across the entirety of frame 802, even rounding sides 814 and 816. In various embodiments, a lower interior surface 810 can have a channel for slidably coupling with interchangeable filters. Area 820 will be described in further detail with respect to FIG. 8C.

FIG. 8B is an example embodiment of a dive mask frame 800 having a slot 806 with a rounded upper proximal edge 804 from a close side view of side 816. As shown, slot 806 may extend down side 816 and 814 to a brow region 818 of frame 800.

FIG. 8C is an example embodiment of an area 820 dive mask frame 802 having a round lock receiving hole 808 and a slot 806 with a chamfered upper proximal edge 804 from a close upper front-side perspective view. Depressions 822 can slidably receive a half-spherical protuberance 826 of a rotatable lock tab 824, as shown in FIG. 8D, and are of complementary size.

FIG. 8D is an example embodiment of a rotatable lock tab 824 for use with a dive mask frame (e.g. 802 of FIG. 8C) having a round lock receiving hole (e.g. 808 of FIG. 8C) from a lower-side perspective view. A gap 830 between two or more arrow shaped holders 828 can be formed between flat or other shaped opposing interior sides 832 of the holders 828. Holders have chamfered lead exterior surfaces 833 such that when pushed through lock receiving hole (e.g. 808 of FIG. 8C) gap 830 is closed by opposing interior sides 832 is narrowed. Once ridge 836 passes a lower opening (e.g. 834 of FIG. 8C) of the hole, gap 830 broadens substantially, and rotatable lock tab 824 is held in position such that it does not fall out of the hole but can still be rotatable within the hole. Grip features 836 can be provided to improve traction between users and rotatable lock tab 824 and in the example embodiment a plurality of rounded ridges are provided. Various other grip features can also be used.

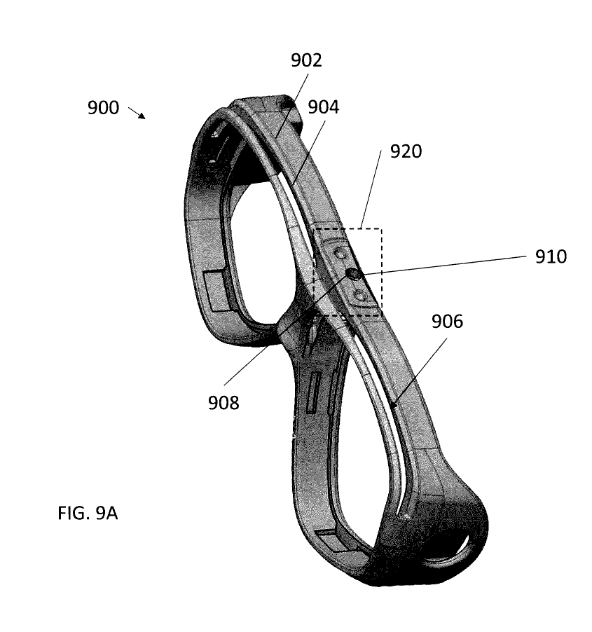

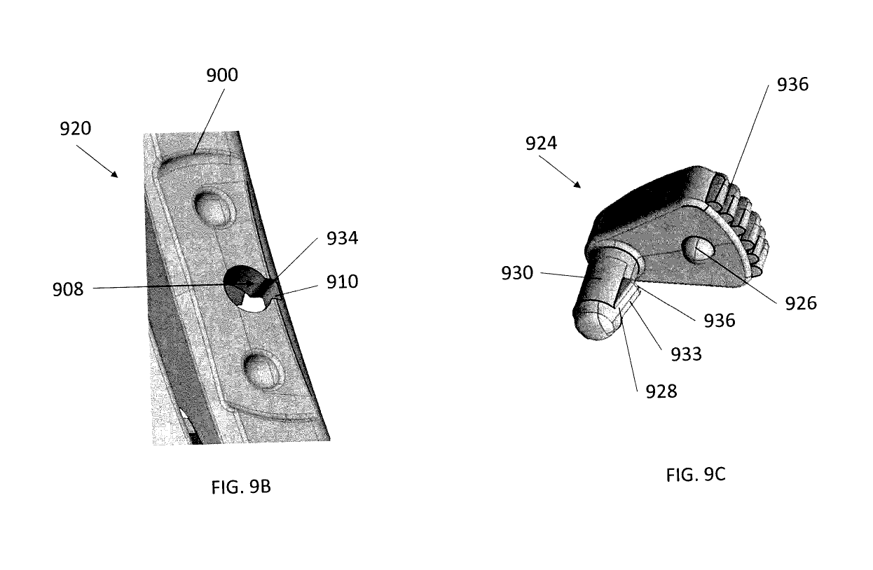

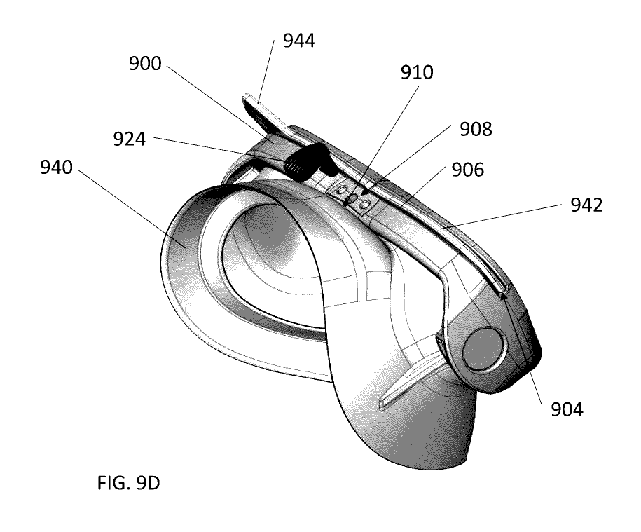

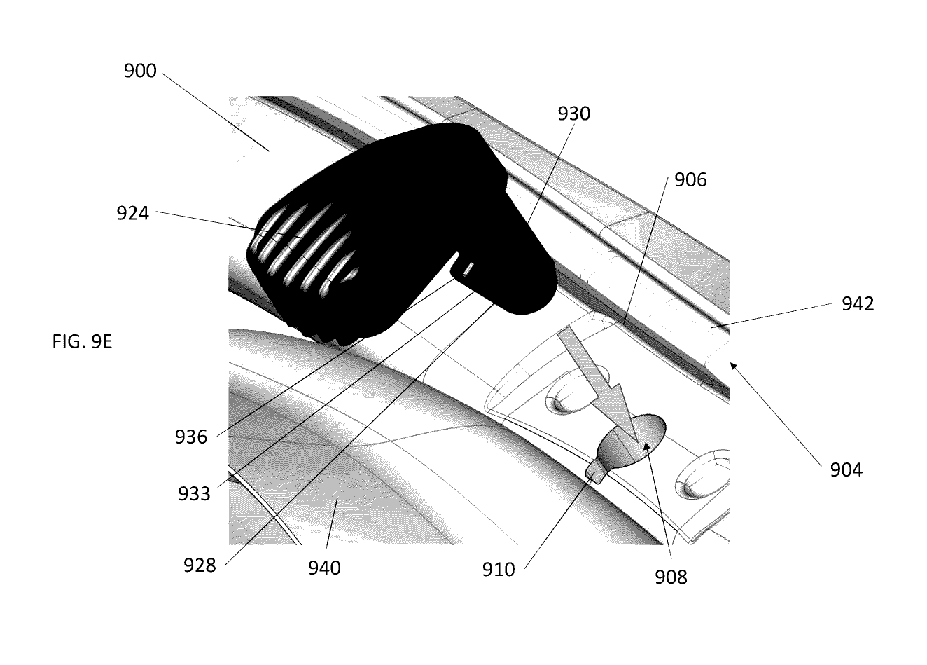

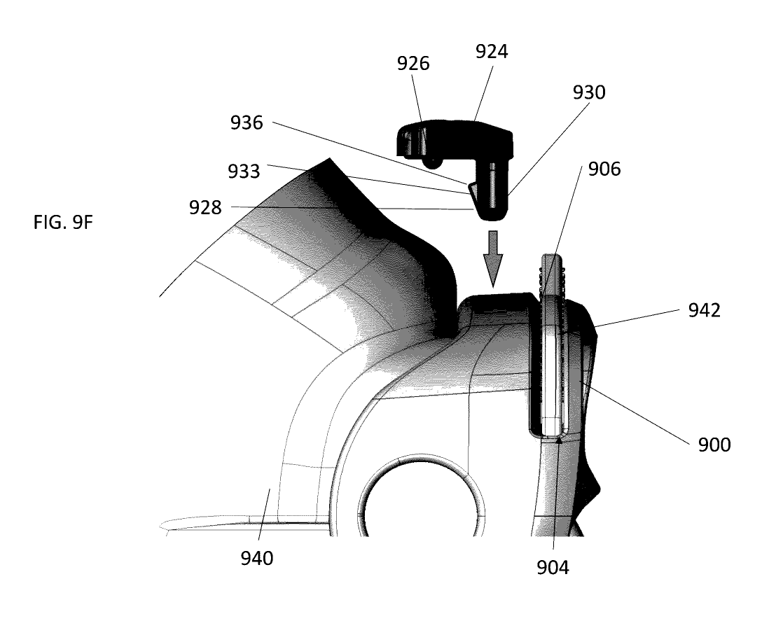

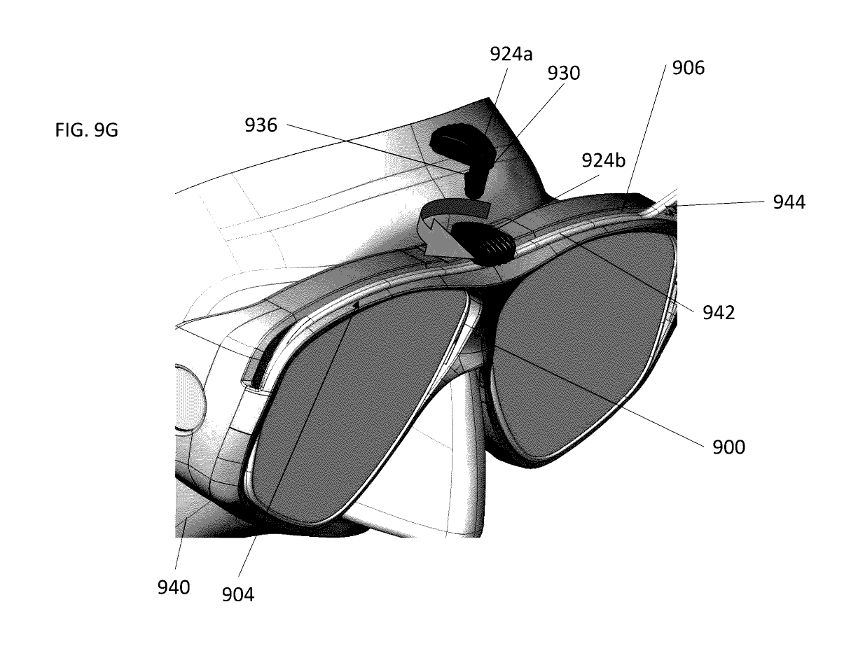

FIG. 9A is an example embodiment of a dive mask frame 900 having a round lock receiving hole 908 with a notch 910 and a slot 906 with a chamfered upper proximal edge 904 from an upper front-side perspective view. This embodiment can be similar to that shown in FIG. 8 and have many similar features except for notch 910 and rotatable lock tab 924.

FIG. 9B is an example embodiment of an area 918 dive mask frame 900 having a round lock receiving hole 908 with a notch 910 and a slot 906 with a chamfered upper proximal edge 904 from a close upper front-side perspective view.

FIG. 9C is an example embodiment of a rotatable lock tab 924 for use with a dive mask frame (e.g. 900 of FIG. 9A) having a round lock receiving hole (e.g. 908 of FIG. 9AC) with a notch 910 from a lower-side perspective view. A post with a cylindrical body 930 can have a pyramidal holder 928 have chamfered lead exterior surfaces 933. Once ridge 936 passes a lower opening (e.g. 934 of FIG. 9B) of a notch (e.g. 910 of FIG. 9B), rotatable lock tab 924 can be rotated clockwise or counterclockwise and held in position by ridge 936 such that it does not fall out of the hole but can still be rotatable within the hole. Grip features 936 can be provided to improve traction between users and rotatable lock tab 924 and in the example embodiment a plurality of rounded ridges are provided. Various other grip features can also be used. If a user wishes to remove rotatable lock tab 924, the user can rotate it back to its original position where pyramidal holder 928 is aligned with notch 910 and remove it.

FIG. 9D is an example embodiment of a dive mask frame 900 having a round lock receiving hole 908 with a notch 910 and a slot 904 with a chamfered upper proximal edge 906 with mask skirt 940, forming a seal between a divers face and mask frame 900, attached and interchangeable filter 942 with a gripping tab 944 inserted into slot 904 from an upper rear-side perspective view. Also shown is a rotatable lock tab 924 in position to be inserted into round lock receiving hole 908 with a notch 910.

FIG. 9E is an example embodiment of a dive mask frame 900 having a round lock receiving hole 908 with a notch 910 and a slot 904 with a chamfered upper proximal edge 906 with mask skirt 940 attached and interchangeable filter 942 inserted from a close upper rear-side perspective view showing insertion orientation for a rotatable lock tab 924, features of which are described with respect to FIG. 9C.

FIG. 9F is an example embodiment of a dive mask frame 900 having a round lock receiving hole (not shown) with a notch (not shown) and a slot 904 with a chamfered upper proximal edge 906 with mask skirt 940 attached and interchangeable filter 942 inserted from a close side perspective view showing insertion orientation for a rotatable lock tab 924, features of which are described with respect to FIG. 9C.

FIG. 9G is an example embodiment of a dive mask frame 900 having a round lock receiving hole with a notch and a slot 904 with a chamfered upper proximal edge 906 with mask skirt 940 attached and interchangeable filter 942 inserted from a close upper front-side perspective view showing pre-insertion rotatable lock tab 924a and post-insertion rotated rotatable lock tab 924b with rotation orientation indicated by the arrow. As shown, interchangeable filter 942 is locked into place in slot 904 after rotatable lock tab 924b is turned.

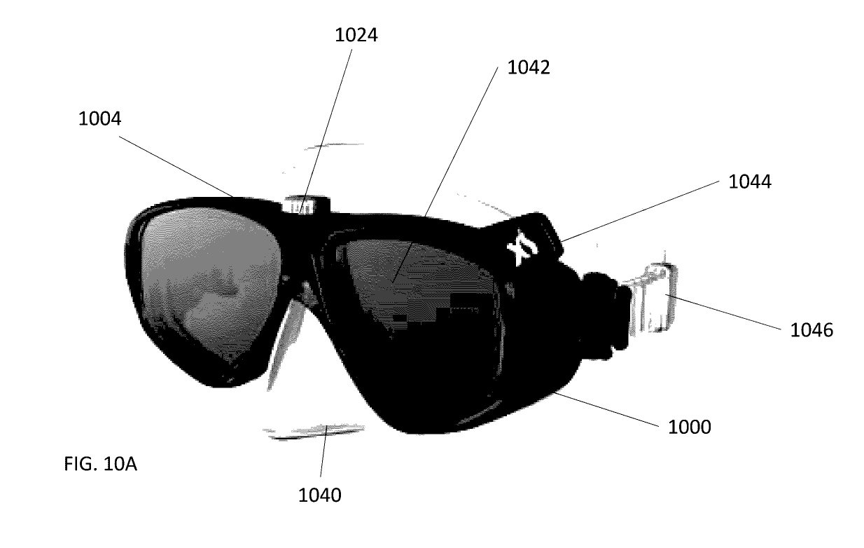

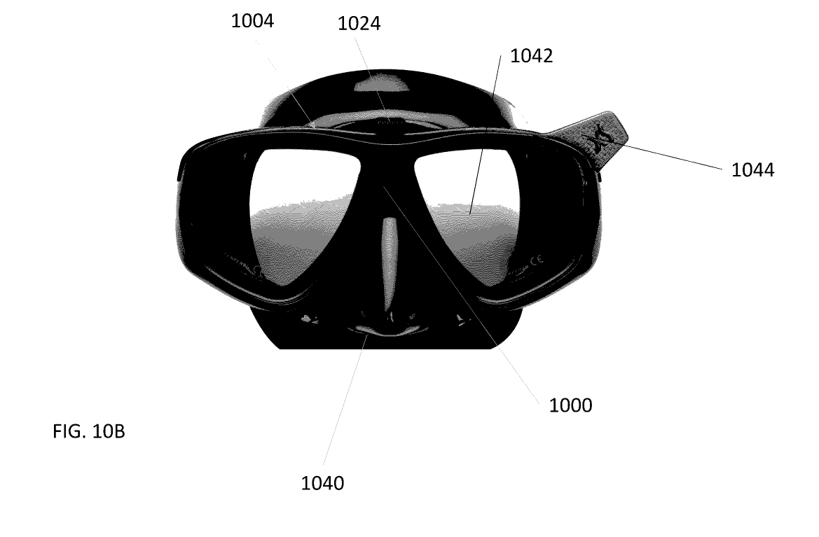

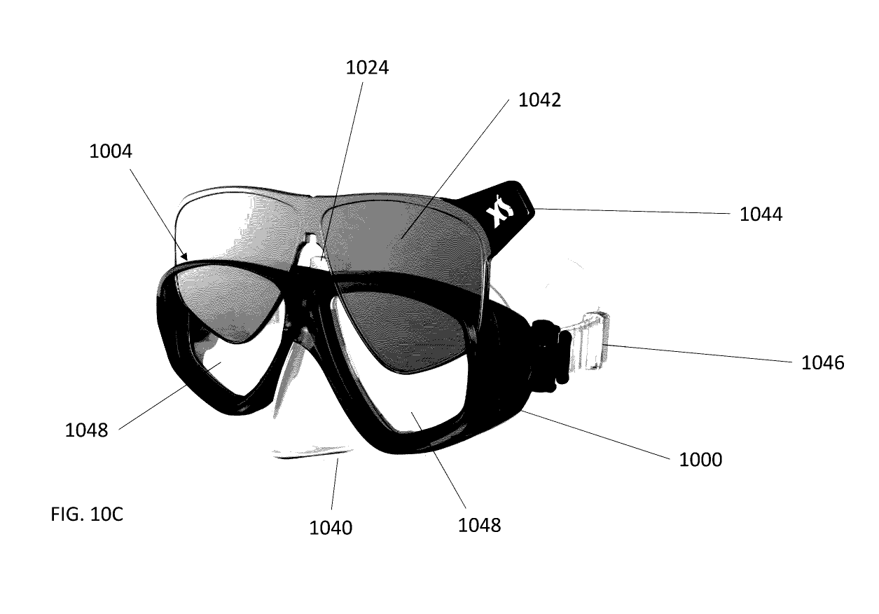

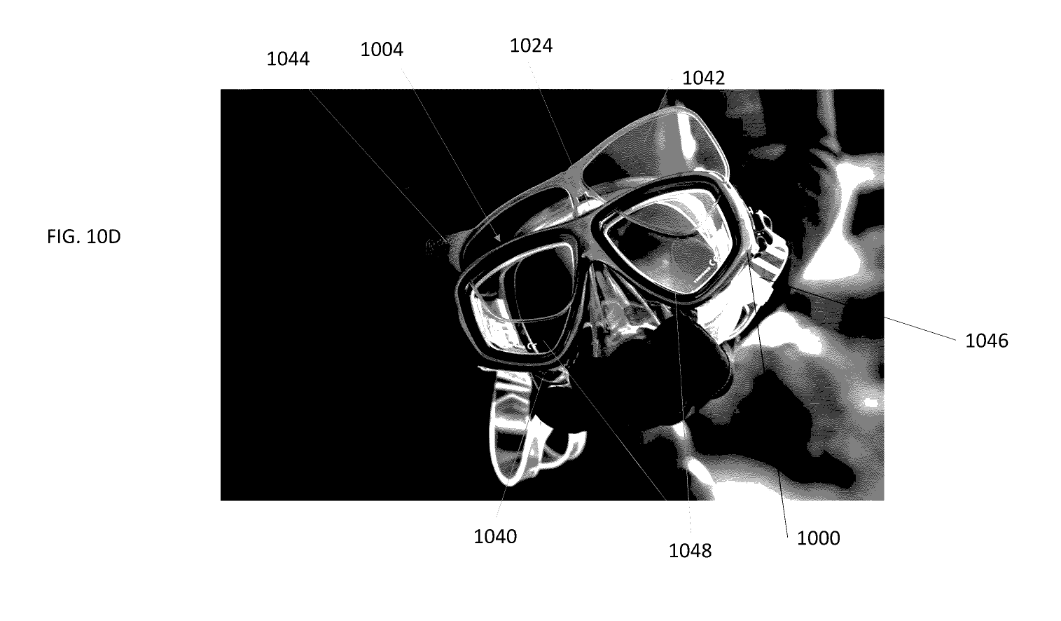

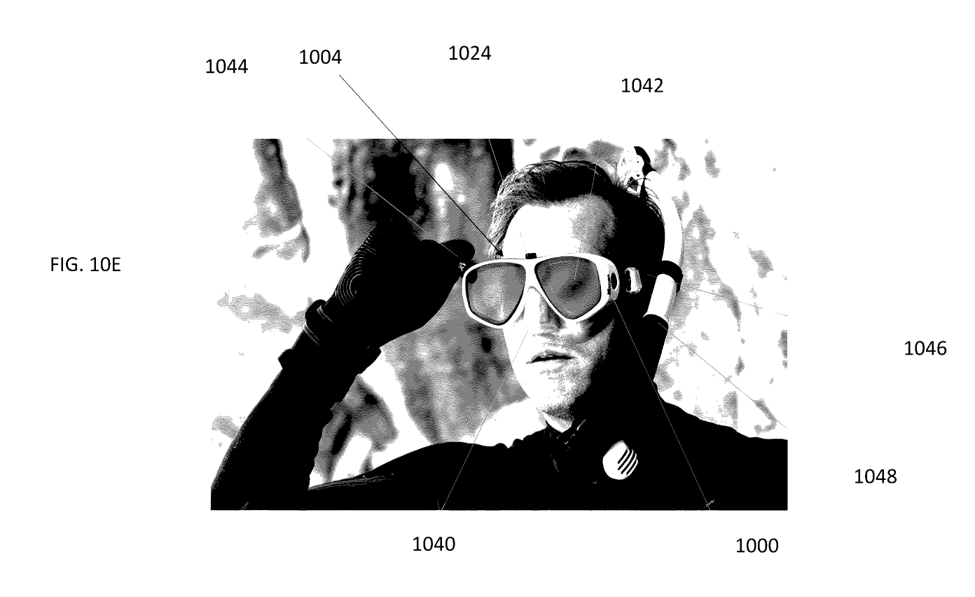

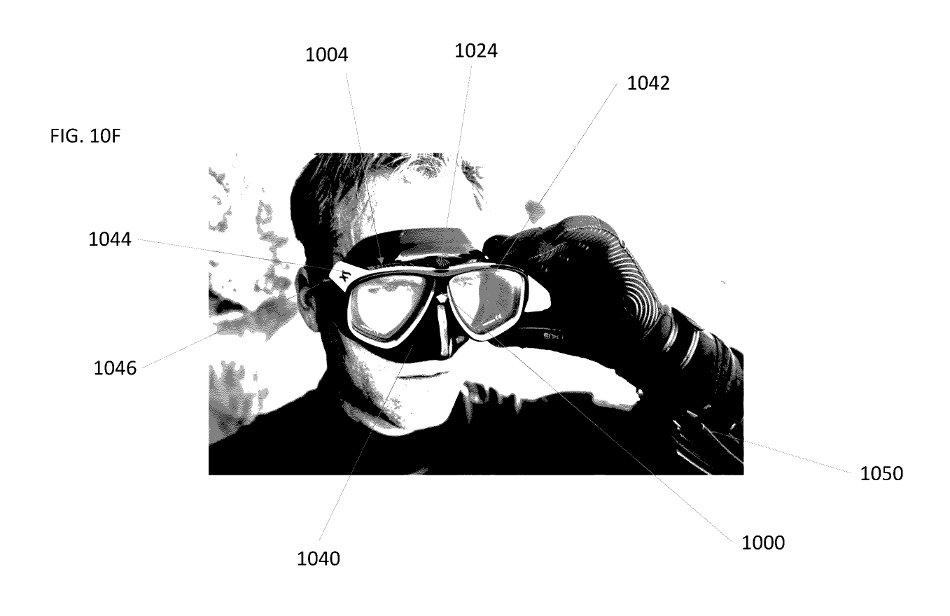

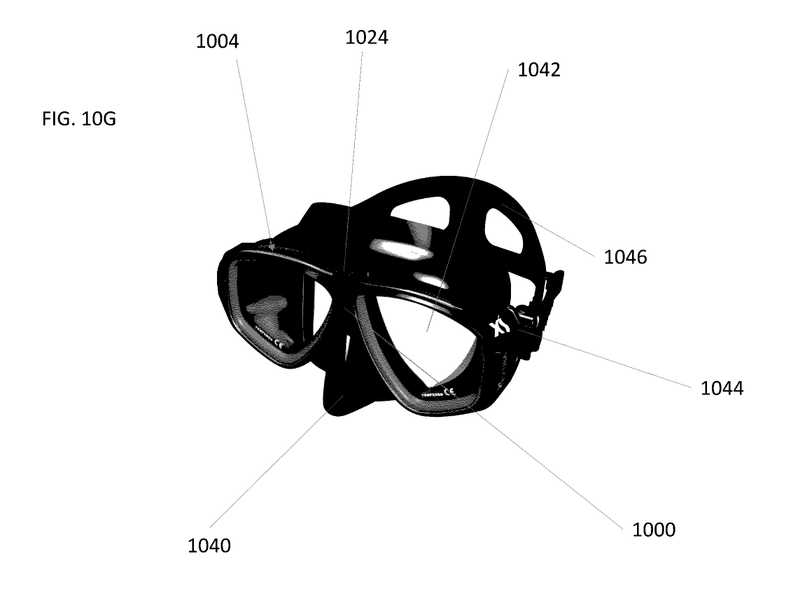

FIG. 10A is an example embodiment of a dive mask frame 1000 with mask skirt 1040 and adjustable headband 1046 attached and interchangeable filter 1042 with a gripping tab 1044 inserted in a slot 1004 with rotatable lock 1024 in locked position from an upper front-side perspective view.

FIG. 10B is an example embodiment of a dive mask frame 1000 with mask skirt 1040 attached and interchangeable filter 1042 with a gripping tab 1044 inserted in slot 1004 inserted with rotatable lock in locked position from a front view.

FIG. 10C is an example embodiment of a dive mask frame 1000 with mask skirt 1040 and adjustable headband 1046 attached, rotatable lock 1024 in unlocked position and interchangeable filter 1042 with gripping tab 1044 not fully inserted from an upper front-side perspective view. Also shown are lenses 1048 which maintain a waterproof seal around a diver's eye area along with other components shown.

FIG. 10D is an example embodiment of a diver manipulating a dive mask frame 1000 with mask skirt 1040 and adjustable headband 1046 attached and rotatable lock 1024 in unlocked position from an upper front view. As shown, the diver is holding interchangeable filter 1042 by gripping tab 1044 such that interchangeable filter 1042 is not fully inserted in slot 1004.

FIG. 10E is an example embodiment of a diver wearing a snorkel 1048 coupled with an adjustable headband 1046 attached to a dive mask frame 1000 with mask skirt 1040 and attached and interchangeable gray filter 1042 inserted in slot 1004 of dive mask frame 1000 and a rotatable lock 1024 in locked position from a front-side perspective view.

FIG. 10F is an example embodiment of a diver wearing an interchangeable filter lens caddy 1050 and a dive mask frame 1000 with mask skirt 1040 and adjustable headband 1046 attached and interchangeable amber filter 1042 inserted with rotatable lock 1024 in locked position from an upper front-side perspective view.

FIG. 10G is an example embodiment of a dive mask frame 1000 with mask skirt 1040 and adjustable headband 1046 attached and interchangeable amber filter 1042 inserted with rotatable lock 1024 in locked position from an upper front-side perspective view.

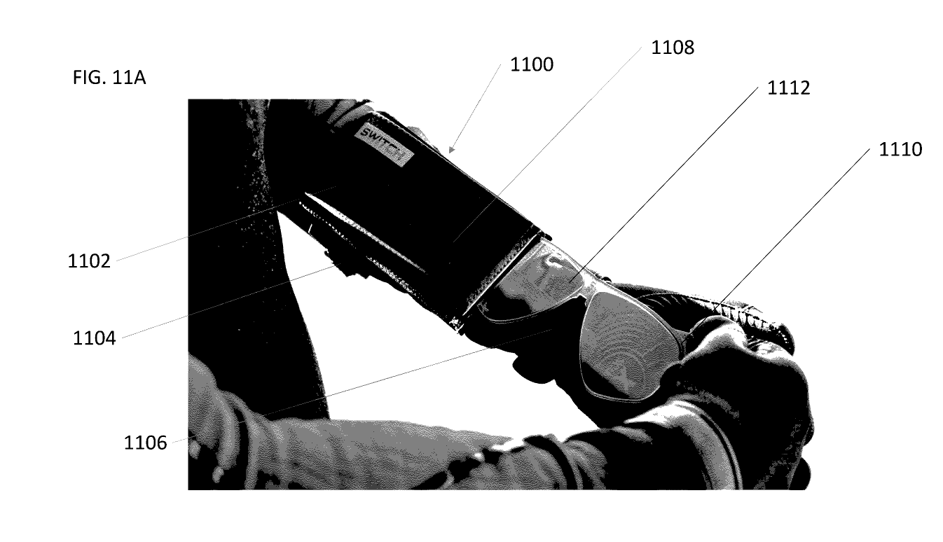

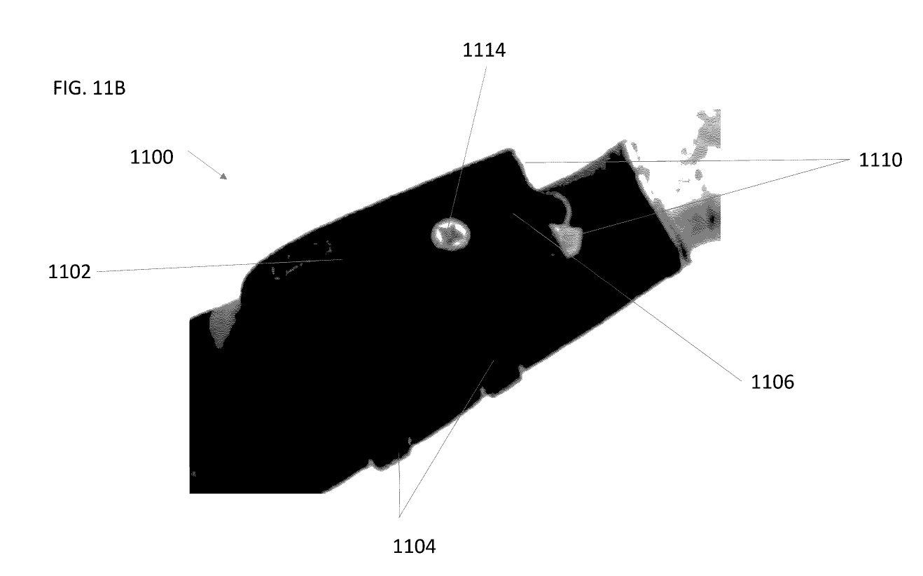

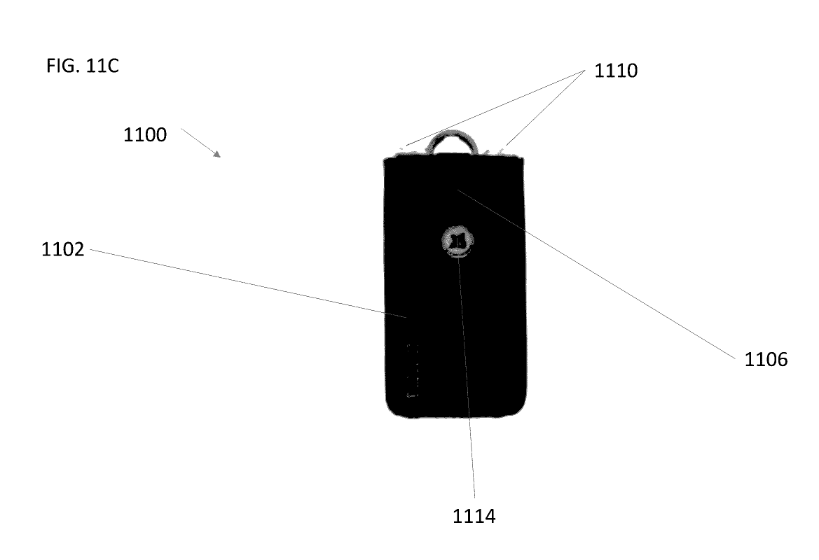

FIG. 11A is an example embodiment of a diver removing an interchangeable filter 1112 with a gripping tab 1110 for use with a dive mask from an interchangeable filter lens caddy 1100, from an upper front-side perspective view. Interchangeable filter lens caddy 1100 can include a body 1102 with one or more internal compartments, sized similarly but slightly larger than interchangeable filter 1112. Body 1102 can be secured to a diver's wrist using one or more straps 1104 that can stretch over a diver's hand in embodiments where both ends of strap 1104 are permanently coupled to body 1102. In other embodiments, strap 1104 can be secured using other means such as fasteners, clips and others. Internal compartments within body 1102 can be secured using one or more flaps 1106 which can be permanently coupled to body 1102 at one end and removably coupled at another end using a fastener 1108. In the example embodiment fastener 1108 a Velcro style patch coupled to body 1102 but other fasteners are also contemplated.

In the example embodiment, a diver can carry a plurality of interchangeable lens filters 1112 on a dive. The body has a variety of mounting options in different locations on a diver's body or gear. The embodiment shown can be mount on diver's forearms. The pockets within body 1102 can include a plush lining. In use, a diver can easily add or remove a necessary or desired interchangeable lens filter 1110 and then secure the body in closed orientation with a strap 1106.

FIG. 11B is an example embodiment of a diver wearing an interchangeable filter lens caddy 1100 in a closed orientation, from an upper front-side perspective view.

FIG. 11C is an example embodiment of an interchangeable filter lens caddy 1100 in a closed orientation, from an upper front view.

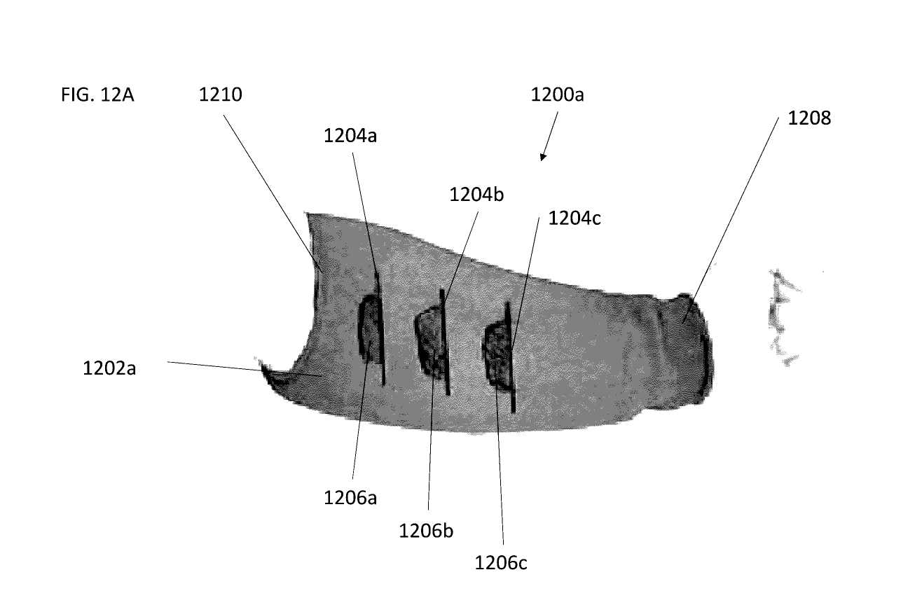

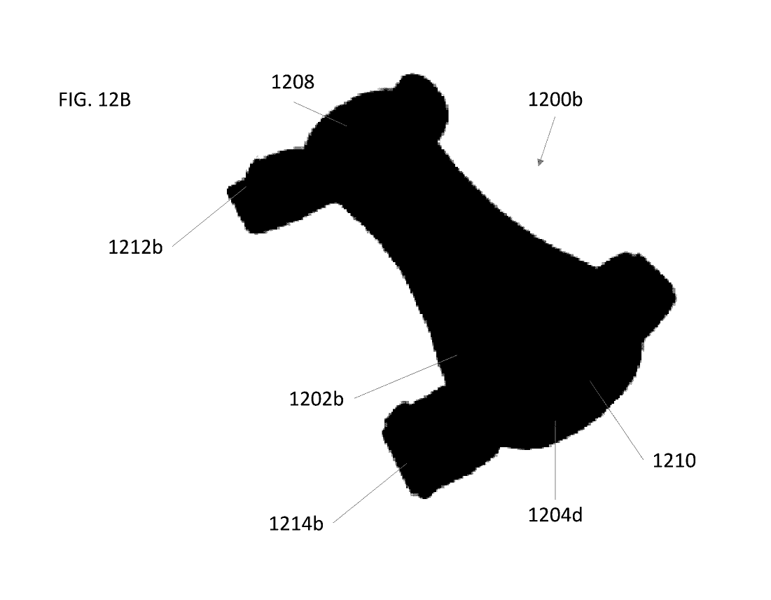

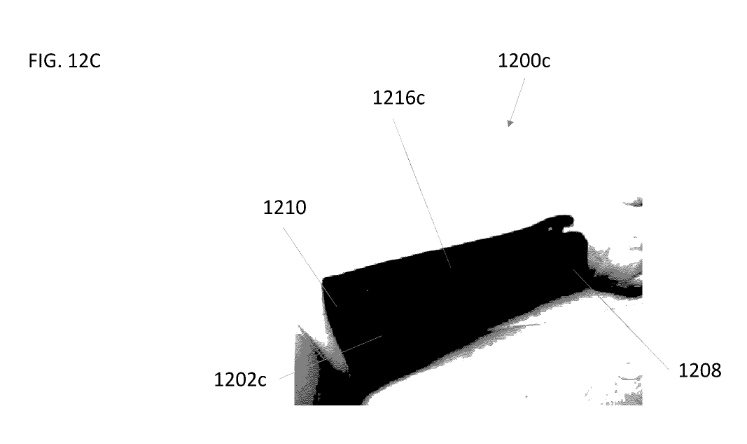

FIG. 12A is an example embodiment of a diver wearing an interchangeable filter lens caddy 1200a from a side view. In the example embodiment, a body 1202a of lens caddy 1200a can include a plurality of pockets with openings 1204a-c in which interchangeable filters 1206a-c cab be held. As shown, openings 1204 a-c can be secure enough that interchangeable filters 1206a-c can partially extend out of their individual pockets created by dividers without falling out or otherwise being lost during normal diving operations. Body 1202a can surround a forearm of a diver from elbow to wrist and in some embodiments a distal end 1208 at a diver's wrist and a proximal end 1210 at a divers elbow can each have elastic or other securing means to maintain body 1202a in position.

FIG. 12B is an example embodiment of an interchangeable filter lens caddy 1200b with straps 1212b, 1214b from an upper oblique perspective view. In the example embodiment a body 1202b can include one or more pockets, accessible through a single opening 1204d. Although shown at proximal end 1210, opening 1204d can also be located at distal end 1208 in some embodiments. Body 1202b is securable to a diver's forearm using a wrist strap 1212b and elbow strap 1214b located at distal end 1208 and proximal end 1210 respectively.

FIG. 12C is an example embodiment of a diver wearing an interchangeable filter lens caddy 1200c with a zipper 1216c from an upper back-side view. In the example embodiment body 1202c includes a zipper 1216c extending from a distal end 1208 to a location near proximal end 1210 but does not extend the entire length of body 1202c. Zipper 1216c can be unzipped in order to allow the diver to more easily remove it and zipped to provide a tighter fit for the diver.

Lens caddies in various embodiments can be neoprene material and can also be referred to as pouches. In some embodiments the lens caddy concepts can be integrated into a wetsuit or other diving suit such that they are not a secondary accessory but rather a feature of the suit itself. Additionally, in some embodiments D-rings on lens caddies can allow divers to attach to BC's, as can loops or webbing.

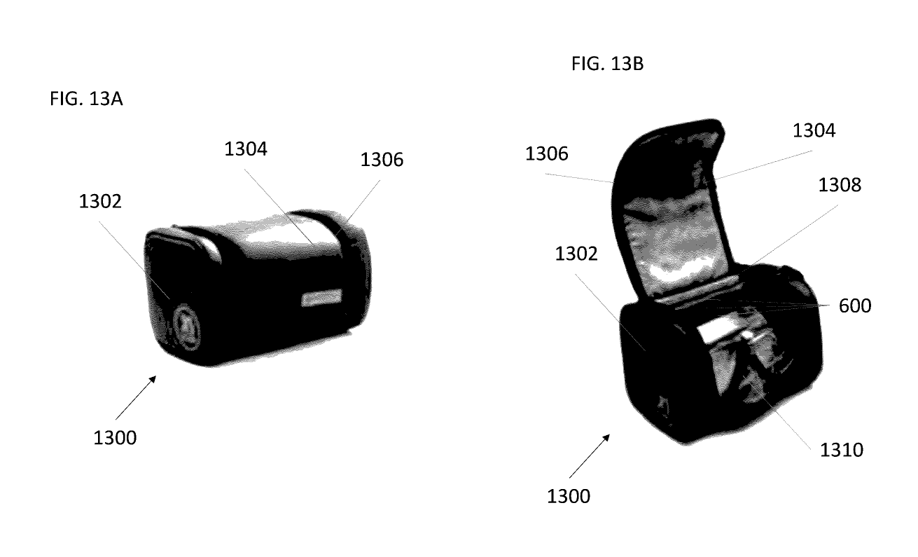

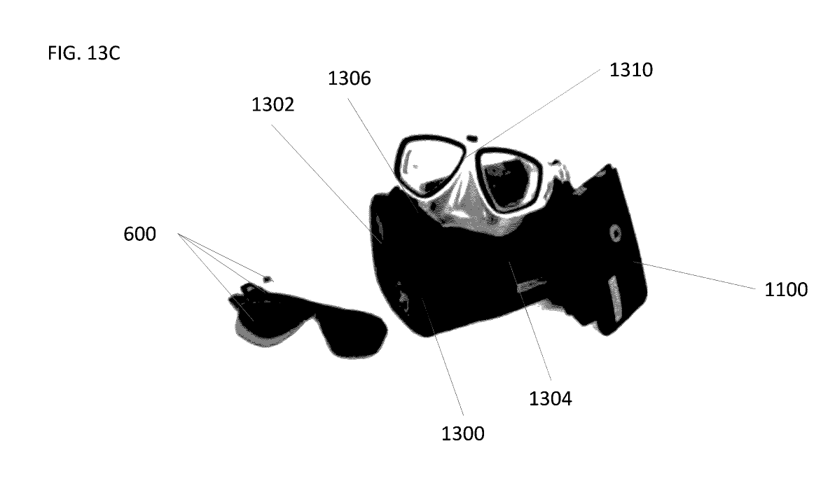

FIG. 13A is an example embodiment of a closed carrying case 1300 having a body 1302 with a sealable flap 1304 to access an interior compartment from a side perspective view. In the example embodiment sealable flap 1304 can be closed with a zipper 1306. In some embodiments multiple sub-compartments exist within carrying case 1300. In some embodiments one or more drain holds can allow water to flow out of the carrying case 1300 to avoid standing water within the case. A side handle can be attached to body 1302 for convenient carrying.

FIG. 13B is an example embodiment of a carrying case 1300 having a body 1302 with an open sealable flap 1304 to access an interior compartment from a side perspective view. In the example embodiment individual pockets are formed by dividers 1308 are sized to hold interchangeable lens filters 600. Also shown is a dive mask 1310.

FIG. 13C is an example embodiment of a carrying case 1300 having a body 1302 with a closed sealable flap 1304 to access an interior compartment from a side perspective view. In the example embodiment a lens caddy 1100, interchangeable lenses 600 and dive mask 1310 are also shown.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. An enhanced visibility diving mask system for a diver, comprising:
a diving mask, having a diving mask body with at least one slot operable to receive and maintain at least one interchangeable lens in position in front of the diver's eyes during a dive; and
a first interchangeable filtering lens, wherein the first interchangeable filtering lens is operable to be removed from the diving mask body by the diver during an underwater dive and replaced by a second interchangeable filtering lens.

2. The enhanced visibility diving mask system of claim 1, wherein the first interchangeable filtering lens filters a first set of wavelengths of light from reaching the diver's eyes.

3. The enhanced visibility diving mask system of claim 2, wherein the second interchangeable filtering lens filters a second set of wavelengths of light from reaching the diver's eyes that are at least somewhat different than the first set of wavelengths.

4. The enhanced visibility diving mask system of claim 1, wherein the interchangeable filtering lenses further comprise a gripping tab that extends at least partially out of the slot when the interchangeable filtering lenses are fully inserted in the slot.

5. The enhanced visibility diving mask system of claim 1, wherein the slot has at least one chamfered upper edge.

6. The enhanced visibility diving mask system of claim 1, wherein the at least one slot is located primarily along an upper surface of the dive mask body.

7. The enhanced visibility diving mask system of claim 1, wherein one slot is provided and maintains one interchangeable filtering lens in position and wherein the one interchangeable filtering lens covers both of the diver's eyes.

8. The enhanced visibility diving mask system of claim 1, wherein two slots are provided and each slot maintains one interchangeable filtering lens in position individually in front of one of the diver's eyes.

9. The enhanced visibility diving mask system of claim 1, further comprising:
at least one locking mechanism operable to block removal of interchangeable filtering lenses from diving mask body in a locked position and allow removal and replacement of interchangeable filtering lenses from diving mask body in an unlocked position.

10. The enhanced visibility diving mask apparatus of claim 9, wherein the locking mechanism is locked and unlocked by rotating it with respect to the diving mask body.

11. The enhanced visibility diving mask system of claim 9, wherein the locking mechanism extends at least partially over the slot in the locked position.

12. An enhanced visibility diving mask apparatus for a diver, comprising:
a diving mask, having a diving mask body with at least one slot operable to receive and maintain at least one interchangeable lens in position in front of the diver's eyes during a dive.

13. The enhanced visibility diving mask apparatus of claim 12, wherein the slot has at least one chamfered upper edge.

14. The enhanced visibility diving mask apparatus of claim 12, wherein the at least one slot is located primarily along an upper surface of the dive mask body.

15. The enhanced visibility diving mask apparatus of claim 12, wherein one slot is provided and maintains one interchangeable filtering lens in position and wherein the one interchangeable filtering lens covers both of the diver's eyes.

16. The enhanced visibility diving mask apparatus of claim 12, wherein two slots are provided and each slot maintains one interchangeable filtering lens in position individually in front of one of the diver's eyes.

17. The enhanced visibility diving mask apparatus of claim 12, further comprising:
at least one locking mechanism operable to block removal of interchangeable filtering lenses from diving mask body in a locked position and allow removal and replacement of interchangeable filtering lenses from diving mask body in an unlocked position.

18. The enhanced visibility diving mask apparatus of claim 17, wherein the locking mechanism is locked and unlocked by rotating it with respect to the diving mask body and extends at least partially over the slot in the locked position.

19. An enhanced visibility interchangeable filtering lens apparatus, comprising:
a lens body operable to filter a set of one or more wavelengths of light from reaching a diver's eyes during an underwater dive, wherein the lens body is operable to removably fit within a slot of an interchangeable lens dive mask body.

20. The enhanced visibility interchangeable filtering lens apparatus of claim 19, wherein the interchangeable filtering lens body further comprises:
a gripping tab extending at least partially out of the slot when the interchangeable filtering lens is inserted in the slot, such that a diver can remove and replace the interchangeable filtering lens during an underwater dive.
